(19) United States
(12) Patent Application Publication
(10) Pub. No.: US 2014/0050877 A1
(43) Pub. Date: Feb. 20, 2014

(54) OPTICAL INFORMATION RECORDING MEDIUM AND OPTICAL INFORMATION RECORDING MEDIUM LAMINATE

(71) Applicant: Sony Corporation, Tokyo (JP)

(72) Inventors: Yo Ota, Tokyo (JP); Shiori Tashiro, Kanagawa (JP); Koichi Yasuda, Kanagawa (JP); Hiroshi Uchiyama, Miyagi (JP); Shinya Narumi, Tokyo (JP); Kenji Takayanagi, Kanagawa (JP); Mitsuaki Oyamada, Kanagawa (JP); Tetsuhiro Sakamoto, Kanagawa (JP)

(73) Assignee: Sony Corporation, Tokyo (JP)

(21) Appl. No.: 13/959,046

(22) Filed: Aug. 5, 2013

(30) Foreign Application Priority Data
Aug. 17, 2012 (JP) 2012-181030

(51) Int. Cl. G11B 7/2403

(52) U.S. Cl. CPC G11B 7/2403
USPC 428/65.2; 428/64.4

(57) ABSTRACT

There is provided an optical information recording medium including a plurality of laminated resin layers, and an inorganic layer that is formed in an interface between the resin layers. Storage elastic moduli are different when the interface is assumed to be a boundary. An information signal is recorded in the interface.

### CROSS REFERENCES TO RELATED APPLICATIONS

The present application claims priority to Japanese Priority Patent Application JP 2012-181030 filed in the Japan Patent Office on Aug. 17, 2012, the entire content of which is hereby incorporated by reference.

### BACKGROUND

The present application relates to an optical information recording medium and a laminate for an optical information recording medium used in the optical information recording medium, and more particularly, an optical information recording medium capable of forming a recording mark by irradiation with light.

In the past, compact discs (CDs), digital versatile discs (DVDs), Blu-ray Discs (registered trademark), and the like have been widely spread as optical information recording media. In recent years, however, there has been a demand for large capacities of an optical information recording medium to cope with the increasing definition of televisions and the exponential increase in data treated by personal computers (PCs).

As one of the methods of increasing the capacity of an optical information recording medium, a method of recording information three-dimensionally in the thickness direction of the optical information recording medium has been suggested. As a system of an optical information recording medium using such a method, there is a system (hereinafter referred to as a “void recording system”) in which a recording material that foams due to photon absorption is contained in a recording layer and an optical beam is radiated to form recording marks as voids (holes) (for example, see Japanese Unexamined Patent Application Publication No. 2008-176902).

However, since the void recording method is a method of forming a void as a recording mark, as described above, a very high laser power is necessary in recording of an information signal. Accordingly, in order to reduce a laser power necessary to record an information signal, a method of forming a recording mark on an interface between a plurality of laminated resin layers has been suggested (for example, see Japanese Unexamined Patent Application Publication No. 2011-86327).

### SUMMARY

It is desirable to provide an optical information recording medium capable of forming a recording mark on an interface between a plurality of laminated resin layers and a laminate for an optical information recording medium used in the optical information recording medium.

According to a first embodiment of the present application, there is provided an optical information recording medium including a plurality of laminated resin layers, and an inorganic layer that is formed in an interface between the resin layers. Storage elastic moduli are different when the interface is assumed to be a boundary. An information signal is recorded in the interface.

According to a second embodiment of the present application, there is provided a laminate for an optical information recording medium, including a plurality of laminated resin layers, and an inorganic layer that is formed in an interface between the resin layers. Storage elastic moduli are different when the interface is assumed to be a boundary. An information signal is recorded in the interface.

In the embodiments of the present application, the storage elastic moduli are different when the interface is assumed to be the boundary. Therefore, when the vicinity of the interface is irradiated with light, the interface in the vicinity is deformed and recording marks are thus formed. Accordingly, the recording marks can be formed in the interface between the plurality of laminated resin layers. Since the inorganic layer is formed in the interface, the satisfactory recording marks can be formed by controlling heat transfer at the time of recording of an information signal. Accordingly, it is possible to improve the waveform of a reproduced signal.

As described above, according to the embodiments of the present application, it is possible to form the recording mark on the interface between the plurality of laminated resin layers.

Additional features and advantages are described herein, and will be apparent from the following Detailed Description and the figures.

### BRIEF DESCRIPTION OF THE FIGURES

FIG. 1 is a schematic sectional view illustrating an example of one configuration of an optical information recording medium according to a first embodiment of the present application;

FIG. 2 is a sectional view illustrating an example of the configuration of a bulk layer;

FIGS. 3A and 3B are schematic sectional views illustrating examples of the configuration of first and second intermediate layers;

FIG. 4 is a schematic sectional view illustrating recording and reproduction of the optical information recording medium according to the first embodiment of the present application;

FIGS. 5A to 5D are process diagrams illustrating an example of a method of manufacturing the optical information recording medium according to the first embodiment of the present application;

FIGS. 6A to 6D are process diagrams illustrating an example of the method of manufacturing the optical information recording medium according to the first embodiment of the present application;

FIGS. 7A and 7B are process diagrams illustrating an example of the method of manufacturing the optical information recording medium according to the first embodiment of the present application;

FIG. 8 is a schematic sectional view illustrating an example of another configuration of the optical information recording medium according to the first embodiment of the present application;

FIG. 9 is a schematic sectional view illustrating an example of one configuration of an optical information recording medium according to a second embodiment of the present application;

FIGS. 10A and 10B are schematic sectional views illustrating an example of the configuration of first and second intermediate layers;

FIG. 11 is a diagram illustrating recording power dependence of a signal strength of the optical information recording medium according to Examples 1-1 to 1-4 and Comparative Example 1-1;

FIG. 12A is a diagram illustrating a signal waveform of the optical information recording medium according to Example 1-3;

FIG. 12B is a diagram illustrating a signal waveform of the optical information recording medium according to Comparative Example 1-1;

FIG. 13A is a diagram illustrating recording power dependence of a signal strength of the optical information recording medium according to Examples 2-1 and 2-2 and Comparative Example 2-1;

FIG. 13B is a diagram illustrating recording power dependence of a signal strength of the optical information recording medium according to Examples 2-3 and 2-4 and Comparative Example 2-2;

FIG. 14A is a diagram illustrating a signal waveform of the optical information recording medium according to Example 2-2;

FIG. 14B is a diagram illustrating a signal waveform of the optical information recording medium according to Comparative Example 2-1;

FIGS. 15A to 15C are diagrams illustrating signal waveforms of the optical information recording medium according to Example 3-1;

FIGS. 16A to 16C are diagrams illustrating signal waveforms of the optical information recording medium according to Comparative Example 3-1;

FIG. 17A is a diagram illustrating an AEM image of a BiTeZrN layer according to Example 4-1;

FIG. 17B is a diagram illustrating an SEM image of the BiTeZrN layer according to Example 4-1;

FIG. 18A is a diagram illustrating an AFM image of the BiTeZrN layer according to Example 4-1;

FIG. 18B is a diagram illustrating a cross-sectional surface profile of the AFM image illustrated in FIG. 18A;

FIG. 19A is a diagram illustrating an SEM image of a BiTeTiN layer according to Example 4-2;

FIG. 19B is a diagram illustrating an AFM image of a BiTeTiN layer according to Example 4-1;

FIG. 19C is a diagram illustrating a cross-sectional surface profile of an AFM image illustrated in FIG. 19B;

FIG. 20 is a diagram illustrating curing condition dependence of a signal strength of an optical information recording medium according to Reference Examples 5-1 to 5-3;

FIG. 21 is a diagram illustrating curing condition dependence of transmittance of an intermediate layer of a laminate according to Reference Examples 6-1 to 6-5;

FIG. 22 is a diagram illustrating an ATR-IR absorption spectrum of an intermediate layer surface of a laminate according to Reference Examples 7-1 to 7-3;

FIG. 23 is an expanded diagram illustrating a region A illustrated in FIG. 22;

FIG. 24 is an expanded diagram illustrating a region B illustrated in FIG. 22; and

FIG. 25 is a diagram illustrating depth dependence of a C═O group peak strength ratio of an intermediate layer surface of a laminate according to Reference Example 8.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Embodiments of the present application will be described in the following order with reference to the drawings.

1. First embodiment (first example of optical information recording medium capable of recording an information signal on an interface)

1.1 Configuration of optical information recording medium

1.2 Recording principle of optical information recording medium

1.3 Recording and reproduction of optical information recording medium

1.4 Method of manufacturing optical information recording medium

1.5 Advantages

1.6 Modification examples

2. Second Embodiment (second example of optical information recording medium capable of recording an information signal on an interface)

### 1. First Embodiment

### 1.1 Configuration of Optical Information Recording Medium

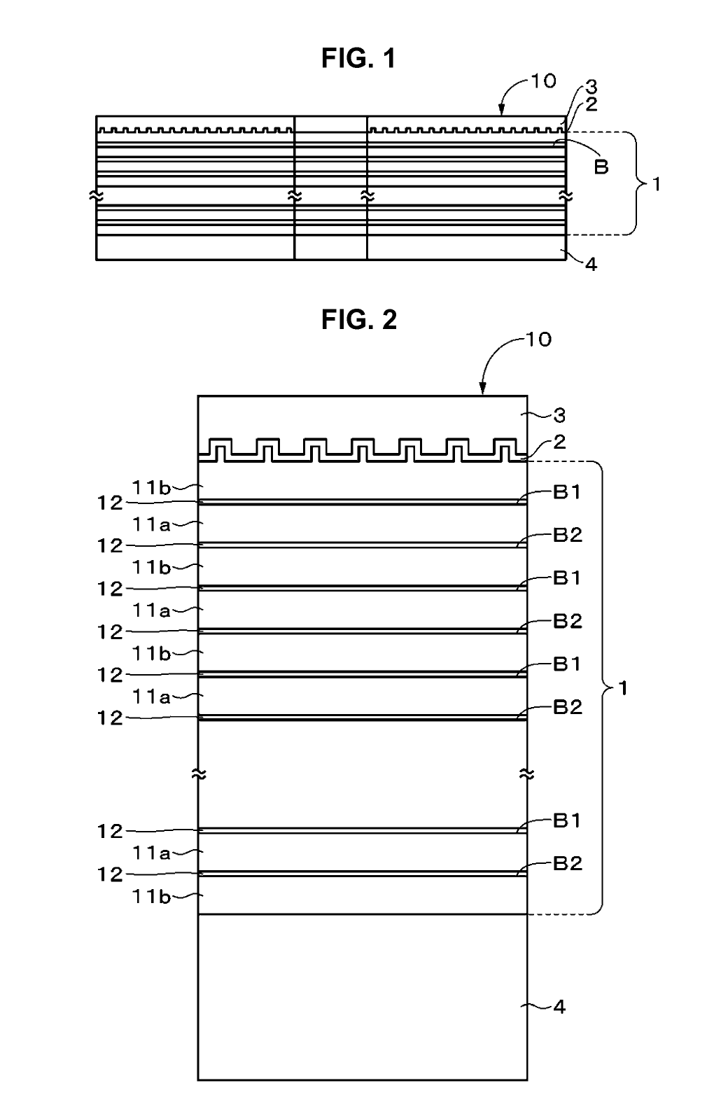

FIG. 1 is a schematic sectional view illustrating an example of one configuration of an optical information recording medium according to a first embodiment of the present application. As illustrated in FIG. 1, an optical information recording medium 10 includes a bulk layer 1, a selective reflection layer 2 formed on the bulk layer 1, and a cover layer 3 formed on the selective reflection layer 2. The optical information recording medium 10 may further include a substrate 4 on an opposite side to the cover layer 3, as necessary. The entire optical information recording medium 10 has a substantially discoid shape. A chucking opening (hereinafter referred to as a center hole) is formed in a middle portion of the optical information recording medium.

In the optical information recording medium 10 according to the first embodiment, an information signal is recorded or reproduced by rotatably driving the optical information recording medium 10 and irradiating an interface B inside the bulk layer 1 with a laser beam from a surface on the side of the cover layer 3. Hereinafter, a surface on an incident side of the laser beam is referred to as an incident surface and an opposite surface to the incident surface is referred to as a rear surface.

Hereinafter, the cover layer 3, the selective reflection layer 2, the bulk layer 1, and the substrate 4 of the optical information recording medium 10 will be described sequentially.

(Cover Layer)

A cover layer 3 may be a layer with transparency, but the embodiment of the present application is not particularly limited and various materials can be used. For example, an organic material such as a plastic material with transparency or an inorganic material such as glass can be used. For example, a known polymer material can be used as the plastic material. Examples of the known polymer material include polycarbonate (PC), acrylic resin (PMMA), cyclo olefin polymer (COP), triacetyl cellulose (TAC), polyester (TPEE), polyethylene terephthalate (PET), polyethylene naphthalate (PEN), polyimide (PI), polyamide (PA), aramid, polyethylene (PE), polyacrylate, polyether sulfone, polysulfone, polypropylene (PP), diacetyl cellulose, polyvinyl chloride, epoxy resin, urea resin, urethane resin, and melamine resin. Examples of the inorganic material include quartz, sapphire, and glass.

The cover layer 3 has, for example, a substantially discoid shape in which a center hole is formed in its middle. One main surface of the cover layer 3 is formed as, for example, an uneven surface and the selective reflection layer 2 is formed on the uneven surface. The uneven surface is formed as a guide groove used to guide a recording or reproduction position. For example, various shapes such as a spiral shape and a concentric shape can be used as the entire shape of the guide groove when viewed from the one main surface of the optical information recording medium 10.

For example, continuous grooves (grooves), a pit line, or a combination thereof can be used as the guide groove. The guide groove may be configured to meander for stabilization of a linear speed or addition of position information (for example, rotation angle information or radius position information).

(Selective Reflection Layer)

The selective reflection layer 2 is formed on the uneven surface side of the cover layer 3. In the optical information recording medium 10, apart from a recording beam (first laser beam) used to record a mark on the bulk layer 1, the selective reflection layer 2 is irradiated separately with a servo beam (second laser beam) used to obtain an error signal of tracking or focus based on the guide groove of the cover layer 3. When the selective reflection layer 2 reflects or absorbs the recording beam at the time of the irradiation with the recording beam, the amount of recording beam reaching the inside of the bulk layer 1 may be attenuated, and thus a recording sensitivity by appearance may deteriorate. For this reason, a reflection layer that has selectivity in which the servo beam is reflected and almost all of the recording beam is transmitted is preferably used as the selective reflection layer 2.

In the optical information recording medium 10, for example, laser beams with different wavelengths are used as the recording beam and the servo beam. A selective reflection layer that has wavelength selectivity in which a beam with the same wavelength as the servo beam is reflected and beams (for example, the recording beam) with other wavelengths are transmitted is used as the selective reflection layer 2.

For example, a laminate film in which a plurality of low-refractive-index layers and a plurality of high-refractive-index layers having different refractive indexes are alternately laminated can be used as the selective reflection layer 2. For example, dielectric layers can be used as the low-refractive-index layer and the high-refractive-index layer. Examples of the material of the dielectric layer include silicon nitride, silicon oxide, tantalum oxide, titanium oxide, magnesium fluoride, and zinc oxide.

(Bulk Layer)

The bulk layer 1 is a laminate (laminate for an optical information recording medium) in which a plurality of resin layers are laminated, and the interface B is formed between the resin layers. An inorganic layer is formed in the interface B. Storage elastic moduli E′ are different when the interface B between the adjacent resin layers is assumed to be a boundary. The bulk layer 1 has a configuration in which an information mark can be formed in the interface B between the plurality of laminated resin layers. The adjacent resin layers may have different refractive indexes. The interface B is formed by a surface (first surface) of one of the adjacent resin layers and a surface (second surface) of the other resin layer, and the storage elastic moduli E′ of the first and second surfaces are preferably different from each other. The information signal is recorded as a concave recording mark with reference to one of the first and second surfaces. Here, when an opening is formed in the inorganic layer at the time of the recording of the information signal, the recording mark is assumed to also include the opening formed in the inorganic layer.

FIG. 2 is a sectional view illustrating an example of the configuration of the bulk layer. As illustrated in FIG. 2, the bulk layer 1 is a laminate in which first intermediate layers 11a which are first resin layers and second intermediate layers 11b which are second resin layers are alternately laminated. The bulk layer 1 includes a plurality of first interfaces B1 and a plurality of second interfaces B2 formed by the first intermediate layers 11a and the second intermediate layers 11b. Inorganic layers 12 are formed in the first interfaces B1 and the second interfaces B2. The first interface B1 is an interface that is formed by the first intermediate layer 11a and the second intermediate layer 11b on the side of the incident surface thereof. The second interface B2 is an interface that is formed by the first intermediate layer 11a and the second intermediate layer 11b on the side of the rear surface thereof. The storage elastic moduli E′ of the incident surface of the first intermediate layer 11a and the rear surface of the second intermediate layer 11b are preferably different from each other. The storage elastic moduli E′ of the incident surface of the second intermediate layer 11b and the rear surface of the first intermediate layer 11a are preferably different from each other. For example, the storage elastic modulus E′ of the first intermediate layer 11a may be different from the storage elastic modulus E′ of the second intermediate layer 11b. The average thicknesses of the first intermediate layer 11a and the second intermediate layer 11b are within a range of, for example, 30 nm to 5 μm.

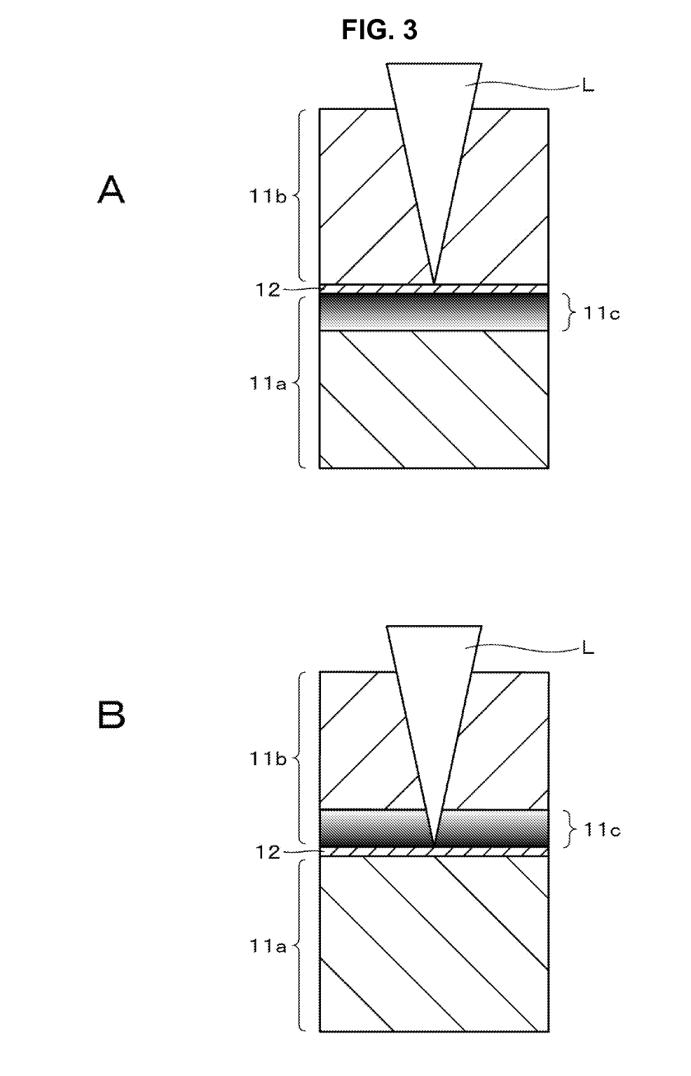

FIGS. 3A and 3B are schematic sectional views illustrating examples of the configurations of the first and second intermediate layers. As illustrated in FIGS. 3A and 3B, any one of the first intermediate layer 11a and the second intermediate layer 11b includes a functional layer 11c adjacent to the interface. More specifically, FIG. 3A illustrates the example in which the functional layer 11c is formed on the side of the first intermediate layer 11a. On the other hand, FIG. 3B illustrates the example in which the functional layer 11c is formed on the side of the second intermediate layer 11b.

The first intermediate layer 11a and the second intermediate layer 11b are, for example, organic intermediate layers that contain an organic material as a main component. For example, different materials are used as the materials of the first intermediate layer 11a and the second intermediate layer 11b. More specifically, for example, materials with different storage elastic moduli E′ are used as the materials of the first intermediate layer 11a and the second intermediate layer 11b. For example, materials with different refractive indexes may be used as the materials of the first intermediate layer 11a and the second intermediate layer 11b. For example, organic and inorganic composite materials can be used as the materials of the first intermediate layer 11a and the second intermediate layer 11b. At least one of the first intermediate layer 11a and the second intermediate layer 11b may contain an additive, as necessary. A material capable of improving recording sensitivity is preferably used as the additive.

For example, at least one kind of material selected from the group consisting of a thermoplastic resin, a thermosetting resin, an energy beam curable resin, and the like can be used as the organic material.

For example, an aromatic polyester such as polyethylene terephthalate, or polyethylene 2,6-naphthalate, polybutylene terephthalate or a polyolefin such as polyethylene or polypropylene can be used as the thermoplastic resin. Alternatively, a polyvinyl such as polystyrene, a polyamide such as nylon 66 (poly(hexamethylenediamine-co-adipic acid)), or an aromatic polycarbonate such as bisphenol A polycarbonate can be used. Further, a resin containing a homopolymer such as polysulfone or a copolymer as a main component, a fluororesin, or the like can also be used. Further, a mixture of the exemplified resins may be used.

For example, a phenol resin, a melamine resin, a urea resin, an epoxy resin, or the like can be used as the thermosetting resin. In particular, in terms of a general purpose (for example, an optical design or a light absorption function), a resin having an epoxy group in a terminal is preferably used.

The energy beam curable resin is a resin that is curable by irradiation with an energy beam. The energy beam refers to an energy beam that serves as a trigger of a polymerization reaction of a radical, a cation, an anion, or the like of an electron beam, an ultraviolet ray, an infrared ray, a laser beam, a visible ray, ionizing radiation (an X-ray, an α ray, a β ray, a γ ray, or the like), a microwave, a high-frequency wave, or the like. An energy beam curable resin composition may be an organic and inorganic composite material. Further, two or more kinds of energy beam curable resin compositions may be used in combination. An ultraviolet curable resin that is cured by an ultraviolet ray is preferably used as the energy beam curable resin composition.

For example, a compound having at least one (meth)acryloyl group can be used as the ultraviolet curable resin. Here, the (meth)acryloyl group means an acryloyl group or a methacryloyl group. For example, a resin containing a monofunctional monomer and a difunctional monomer can be used as the ultraviolet curable resin. For example, benzyl acrylate can be used as the monofunctional monomer. For example, fluorene acrylate or a difunctional urethane acrylate can be used as the difunctional monomer. Specifically, for example, Ogsol EA-0200, Ogsol EA-F5503, Ogsol EA-1000, produced by Osaka Gas Chemical Co., Ltd. can be used as the fluorene acrylate. Specifically, for example, M1200 produced by Toagosei Co., Ltd. can be used as the difunctional urethane acrylate. Further, a fluorine-based ultraviolet curable resin may be used as the ultraviolet curable resin. Specifically, for example, 2,2,2-trifluoroethyl acrylate (Osaka Gas Chemical Co., Ltd., V3F) can be used as the fluorine-based ultraviolet curable resin.

For example, a nano-composite produced by compounding an organic material and an inorganic material on a nano-level can be used as the organic and inorganic composite material.

An adhesive, a silicon resin, or the like can be used as a material other than the above-mentioned materials. For example, a pressure sensitive adhesive (PSA) or a hard pressure sensitive adhesive (HPSA) can be used as the adhesive. One of the first intermediate layer 11a and the second intermediate layer 11b may be used as a layer that includes a thermosetting resin or an energy beam curable resin and the other intermediate layer may be used as a layer that includes an adhesive or a silicon resin.

The functional layer 11c is an absorption layer (region) that absorbs a laser beam used to record the information signal. Any one of a linear absorption layer that linearly absorbs a laser beam and a nonlinear absorption layer that nonlinearly absorbs a laser beam may be used as the absorption layer. In terms of simplicity of a producing process, the linear absorption layer is preferably used. Here, the linear absorption layer is an absorption layer that mainly performs linear absorption between nonlinear absorption and linear absorption. The nonlinear absorption layer is an absorption layer that mainly performs nonlinear absorption between nonlinear absorption and linear absorption. In terms of simplicity of the producing process, an oxidation layer (oxidation region) formed of a polymer resin material containing oxygen is preferably used as the linear absorption layer. The thickness of the functional layer 11c may be a thickness equal to or less than the thickness of the first intermediate layer 11a or the second intermediate layer 11b including the functional layer 11c, but the embodiment of the present application is not particularly limited. However, the functional layer 11c is preferably thin with a thickness of, for example, about 100 nm.

The functional layer 11c is, for example, an inclined layer of which a composition varies in its thickness direction. When the functional layer 11c is an oxidation layer, the functional layer 11c is an inclined layer of which an oxygen concentration varies in its thickness direction. For example, the oxygen concentration is higher on the interface side.

The functional layer 11c may be a layer of which an optical absorption property is improved by varying the composition or the like near the surface of the first intermediate layer 11a or the second intermediate layer 11b, or may be a layer that is formed by separately forming a layer formed of an organic material or a composite material of organic and inorganic materials or the like on the surface of the first intermediate layer 11a or the second intermediate layer 11b. In terms of the light absorption property, a colored material containing a pigment or the like is preferably used as the organic material or the composite material of organic and inorganic materials.

The inorganic layer 12 is an inorganic layer (hereinafter appropriately referred to as an “inorganic layer with a non-optical absorption property”) that has a non-optical absorption property for a beam used to record the information signal or is an inorganic layer (hereinafter appropriately referred to as an “inorganic layer with an optical absorption property”) that has an absorption property for the beam used to record the information signal. The two kinds of inorganic layers may be combined according to the characteristics of the desired optical information recording medium 10. When the inorganic layer with a non-optical absorption property is used as the inorganic layer 12, a satisfactory recording mark can be formed by controlling heat transfer at the time of the formation of the recording mark. Accordingly, the waveform of a reproduced signal can be improved. When the inorganic layer with an optical absorption property is used as the inorganic layer 12, it is possible to obtain not only the advantage of improving the above-described waveform of a reproduced signal but also the advantage of improving CNR (signal-to-noise ratio) recording sensitivity. In terms of multiple layers, the inorganic layer with a non-optical absorption property is preferably used. However, even in the inorganic layer with an optical absorption property, high transmittance can be obtained by reducing the film thickness of the inorganic layer with an optical absorption property. Thus, it is possible to realize multiple layers comparable to a case in which the inorganic layer with a non-optical absorption property is used.

The inorganic layer 12 with a non-optical absorption property refers to an inorganic layer in which an extinction coefficient k satisfies a relation of k≦0.05. In terms of an improvement of transmission characteristics of the optical information recording medium 10, the extinction coefficient k preferably satisfies a relation of 0.01<k. The inorganic layer 12 with an optical absorption property refers to an inorganic layer in which an extinction coefficient k satisfies a relation of 0.05<k. Here, the extinction coefficient k of the inorganic layer 12 is obtained by forming the inorganic layer 12 on a Si substrate and measuring the extinction coefficient k of the inorganic layer 12 using a spectroscopic ellipsometer.

For example, a dielectric material can be used as the material of the inorganic layer 12 with a non-optical absorption property. Any material can be used, as long as the material has a non-absorption property for a beam used to record the information signal in a thin-film state. For example, the dielectric material contains at least one kind of material selected from a group consisting of an oxide, a nitride, a sulfide, a carbide, and a fluoride.

For example, an oxide of one or more kinds of elements selected from a group consisting of In, Zn, Sn, Al, Si, Ge, Ti, Ga, Ta, Nb, Hf, Zr, Cr, Bi, and Mg can be used as the oxide. For example, a nitride of one or more kinds of elements selected from a group consisting of In, Sn, Ge, Cr, Si, Al, Nb, Mo, Ti, Nb, Mo, Ti, W, Ta, and Zn can be used as the nitride. A nitride of one or more elements selected from a group consisting of Si, Ge, and Ti can be preferably used. For example, a Zn sulfide can be used as the sulfide. For example, a carbide of one or more kinds of elements selected from the group consisting of In, Sn, Ge, Cr, Si, Al, Ti, Zr, Ta, and W can be used as the carbide. A carbide of one or more elements selected from the group consisting of Si, Ti, and W can be preferably used. For example, a fluoride of one or more elements selected from the group consisting of Si, Al, Mg, Ca, and La can be used as the fluoride. Examples of a mixture include ZnS—SiO₂, SiO₂—In₂O₃—ZrO₂ (SIZ), SiO₂—Cr₂O₃—ZrO₂ (SCZ), In₂O₃—SnO₂ (ITO), In₂O₃—CeO₂ (ICO), In₂O₃—Ga₂O₃ (IGO), In₂O₃—Ga₂O₃—ZnO (IGZO), Sn₂O₃—Ta₂O₅ (TTO), TiO₂—SiO₂, Al₂O₃—ZnO, and Al₂O₃—BaO.

The thickness of the inorganic layer 12 with a non-optical absorption property is preferably greater than 0 nm and less than 20 nm, and is more preferably greater than 0 nm and equal to or less than 10 nm. When the thickness of the inorganic layer 12 is equal to or greater than 20 nm, the recording sensitivity tends to decrease.

A metal, a metal compound, and carbon can be exemplified as the material of the inorganic layer 12 with an optical absorption property. Any material can be used, as long as the material has an absorption property for a beam used to record the information signal in a thin-film state. However, the embodiment of the present application is not limited thereto. For example, a metal such as Ti, V, Mn, Fe, Ag, Cu, Ni, or In, an oxide or a nitride thereof can be exemplified as a specific material of the inorganic layer 12 with an optical absorption property. As specific examples of the metal nitride, TiN, BiTeTiN, and BiTeZrN can be exemplified.

(Substrate)

The substrate 4 has, for example, a substantially discoid shape in which a center hole is formed in its middle. Any material having transparency or opacity can be used as the material of the substrate 4. For example, a plastic material or glass can be used. In terms of formability, a plastic material is preferably used. For example, a polycarbonate-based resin, a polyolefin-based resin, or an acrylic resin can be used as the plastic material. In terms of cost, the polycarbonate-based resin is preferably used.

### 1.2 Recording Principle of Optical Information Recording Medium

In the optical information recording medium having the above-described configuration, recording marks are assumed to be formed in the interfaces B1 and B2 as follows by irradiation with a laser beam.

First, when the functional layer 11c is irradiated with the laser beam, the laser beam is locally absorbed in the functional layer 11c. Next, heat is generated in a portion absorbing the laser beam, and thus the portion itself is decomposed and deformed due to the generated heat. Thereafter, the decomposed and deformed portion is rapidly cooled by the inorganic layer 12 around the portion, and thus abruptly contracted. Thus, a concave recording mark is formed on the surface of the functional layer 11c. The cooling operation by the inorganic layer 12 is considered to be one of the causes forming the satisfactory recording mark. The inorganic layer 12 of the portion adjacent to the portion absorbing the laser beam may be lost due to the generated heat of the portion absorbing the laser beam, and thus an opening may be formed in the inorganic layer 12. The circumference of the opening may be formed with a convex shape protruding with respect to the surface of the inorganic layer 12. In the recording mark formed in this way, for example, HtoL (high to Low) can be obtained as a signal polarity. In the inorganic layer 12 with a non-optical absorption property, the cooling operation occurs. In the inorganic layer 12 with an optical absorption property, a heat generation operation by the absorption of the laser beam occurs in addition to the cooling operation.

### 1.3 Recording and Reproduction of Optical Information Recording Medium

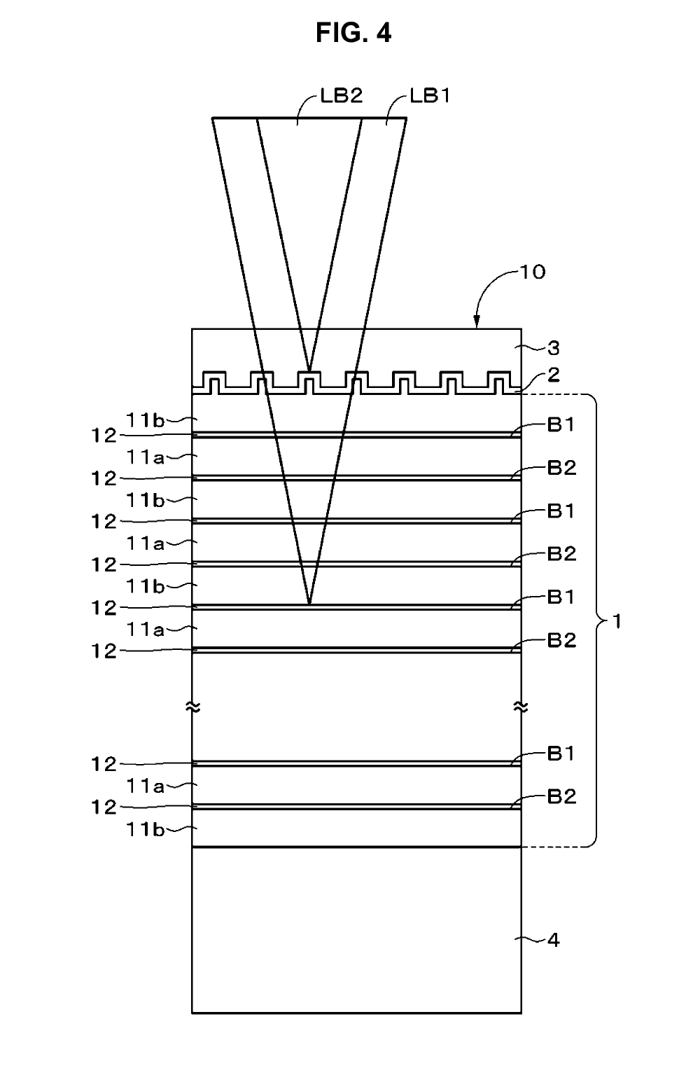

Next, an example of the recording and reproduction of the optical information recording medium according to the first embodiment of the present application will be described with reference to FIG. 4.

In the optical information recording medium 10, the information signal is recorded or reproduced by radiating a first laser beam LB1 to the interface B1 or B2 via an object lens of the side of the cover layer 3 and radiating a second laser beam LB2 to the uneven surface of the cover layer 3.

The first laser beam LB1 is a laser beam that serves as a recording beam or a reproduction beam used to record or reproduce the information signal. The second laser beam LB2 is a laser beam that serves as servo beam used to perform servo control in the recording or the reproduction of the information signal. The optical information recording medium 10 is irradiated with the first laser beam LB1 and the second laser beam LB2 via the common object lens in, for example, a recording reproduction device. A numerical aperture of the object lens is selected from a range of, for example, 0.84 to 0.95. The wavelength of the first laser beam LB1 is different from that of the second laser beam LB2. The wavelength λ1 of the first laser beam LB1 is selected as, for example, a wavelength shorter than the wavelength λ2 of the second laser beam LB2. While the first laser beam LB1 is a blue or blue-violet laser beam that has a wavelength with a range of, for example, 395 nm to 420 nm, the second laser beam LB2 is a red laser beam that has a wavelength with a range of, for example, 640 nm to 680 nm.

### 1.4 Method of Manufacturing Optical Information Recording Medium

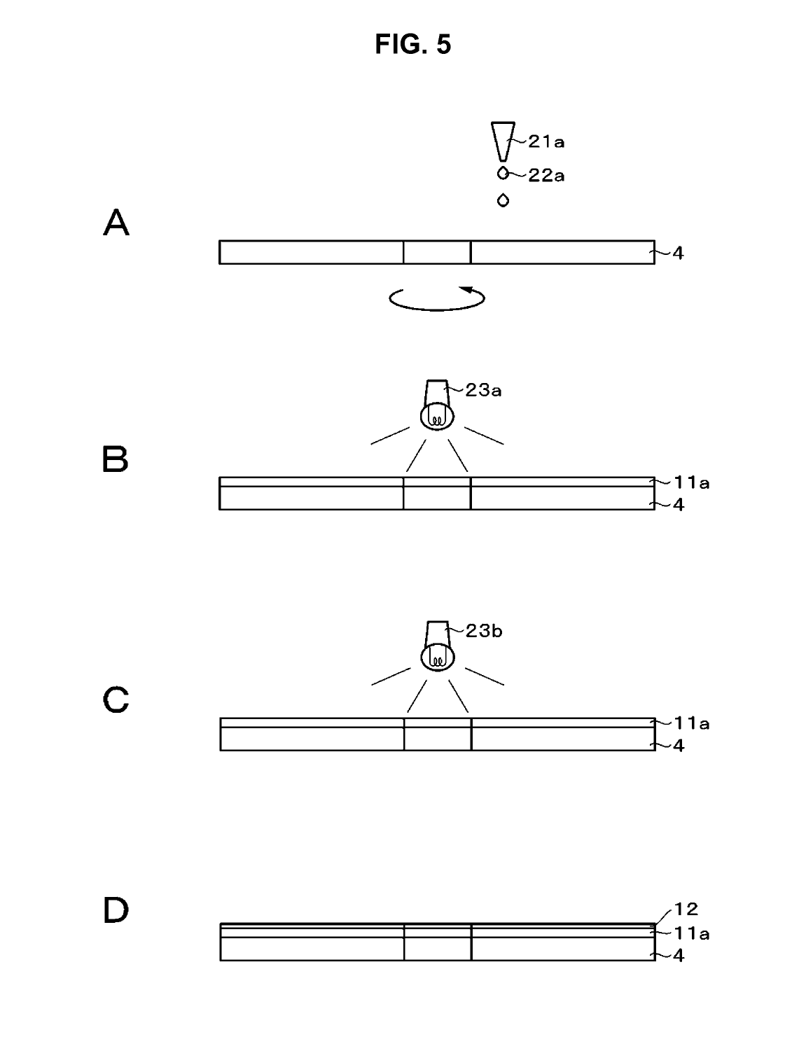

Hereinafter, an example of a method of manufacturing the optical information recording medium 10 according to the first embodiment of the present application will be described with reference to FIGS. 5A to 7B.

(First Applying Process)

First, as illustrated in FIG. 5A, a first resin composition 22a is dropped to the inner circumference of the substrate 4 by an application device 21a and the dropped first resin composition 22a is stretched in the outer circumference direction of the substrate 4 by a spin coating method to form a coated film with a uniform thickness on the substrate 4. For example, a thermosetting resin or an ultraviolet curable resin can be used as the first resin composition 22a. A resin composition that can be used according to this manufacturing method is not limited thereto, but an energy beam curable resin, a thermoplastic resin, or the like can be used in addition to the ultraviolet curable resin.

(First Curing Process)

Next, as illustrated in FIG. 5B, the coated film formed from the first resin composition 22a formed on the substrate 4 is cured by infrared irradiation or ultraviolet irradiation from a beam source 23a. Thus, the first intermediate layer 11a with a uniform thickness is formed on the substrate 4. For example, an IR lamp can be used as the beam source 23a for the infrared irradiation. For example, a UV lamp can be used as the beam source 23a for the ultraviolet irradiation. For example, a high-pressure mercury lamp, a flash UV, or an H valve can be used as the UV lamp.

(First Irradiating Process)

Next, as illustrated in FIG. 5C, an oxidation layer having linear absorption is formed on the surface of the first intermediate layer 11a by ultraviolet irradiation from a beam source 23b. The oxidation layer has a concentration distribution in which an oxygen concentration continuously decreases from the surface in the thickness direction. For example, a high-pressure mercury lamp or a UV lamp such as a flash UV bulb or an H bulb can be used as the beam source 23b for the ultraviolet irradiation. An irradiation power of the ultraviolet irradiation from the beam source 23b is set to be higher than an irradiation power of the infrared irradiation from the beam source 23a.

(First Inorganic Layer Forming Process)

Next, as illustrated in FIG. 5D, the inorganic layer 12 is formed on the surface of the oxidation layer of the first intermediate layer. For example, not only a chemical vapor deposition method (CVD: a technology for depositing a thin film from a vapor phase using a chemical reaction) such as a sputtering method, heat CVD, plasma CVD, or optical CVD but also a physical vapor deposition method (PVD: a technology for forming a thin film by causing a material physically vaporized in vacuum to cohere on a substrate) such as vacuum deposition, plasma-assisted deposition, or ion plating can be used as the method of forming the inorganic layer 12.

(Second Applying Process)

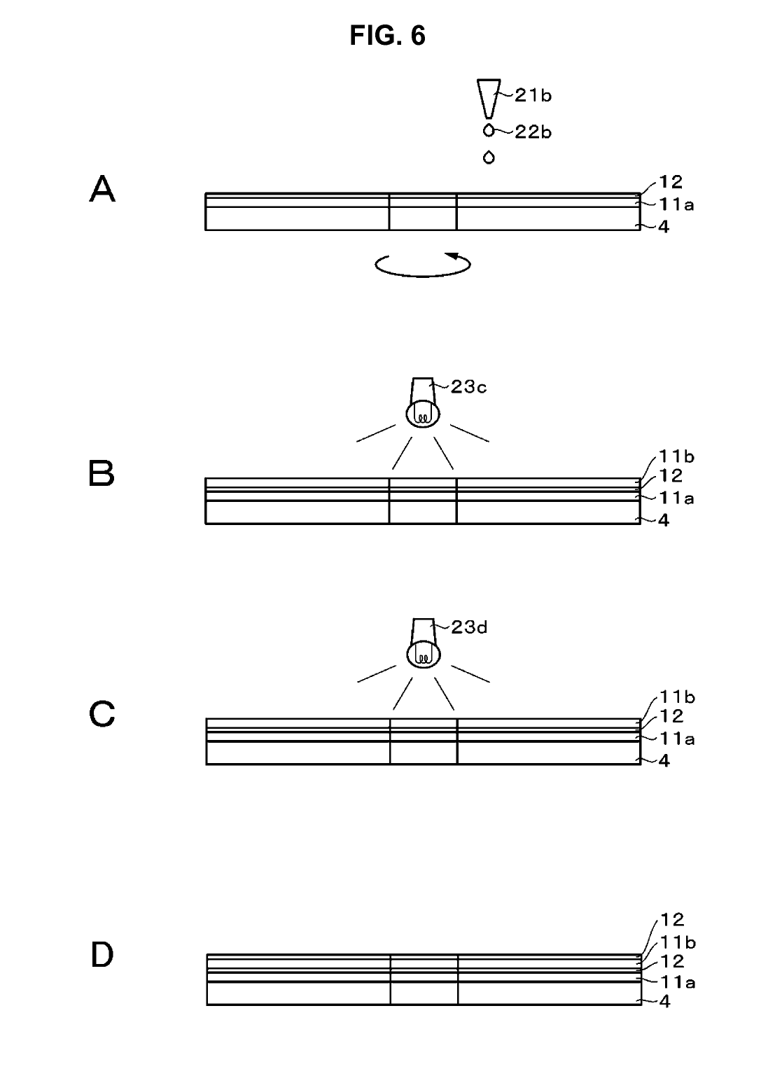

Next, as illustrated in FIG. 6A, a second resin composition 22b is dropped on the inner circumference of the substrate 4 by an application device 21b and the dropped second resin composition 22b is stretched in the outer circumference direction of the substrate 4 by a spin coating method to form a coated film with a uniform thickness on the first intermediate layer 11a. For example, a thermosetting resin or an ultraviolet curable resin can be used as the second resin composition 22b. A resin composition that can be used according to this manufacturing method is not limited thereto, but an energy beam curable resin, a thermoplastic resin, or the like can be used in addition to the ultraviolet curable resin.

(Second Curing Process)

Next, as illustrated in FIG. 6B, the coated film formed of the second resin composition 22b formed on the first intermediate layer 11a is cured by infrared irradiation or ultraviolet irradiation from a beam source 23c. Thus, the first intermediate layer 11a, the inorganic layer 12, and the second intermediate layer are formed on the substrate 4. For example, an IR lamp can be used as the beam source 23c for the infrared irradiation. For example, a UV lamp can be used as the beam source 23c for the ultraviolet irradiation.

(Second Irradiating Process)

Next, as illustrated in FIG. 6C, an oxidation layer having linear absorption is formed on the surface of the second intermediate layer 11b by ultraviolet irradiation from a beam source 23d. The oxidation layer has a concentration distribution in which an oxygen concentration continuously decreases from the surface in the thickness direction. For example, a high-pressure mercury lamp or a UV lamp such as a flash UV bulb or an H bulb can be used as the beam source 23d for the ultraviolet irradiation. Irradiation power of the ultraviolet irradiation from the beam source 23d is set to be higher than irradiation power of the ultraviolet irradiation from the beam source 23c.

(Second Inorganic Layer Forming Process)

Next, as illustrated in FIG. 6D, the inorganic layer 12 is formed on the surface of the oxidation layer of the second intermediate layer. For example, not only a chemical vapor deposition method (CVD: a technology for depositing a thin film from a vapor phase using a chemical reaction) such as a sputtering method, heat CVD, plasma CVD, or optical CVD but also a physical vapor deposition method (PVD: a technology for forming a thin film by causing a material physically vaporized in vacuum to cohere on a substrate) such as vacuum deposition, plasma-assisted deposition, or ion plating can be used as the method of forming the inorganic layer 12.

(Laminating Process)

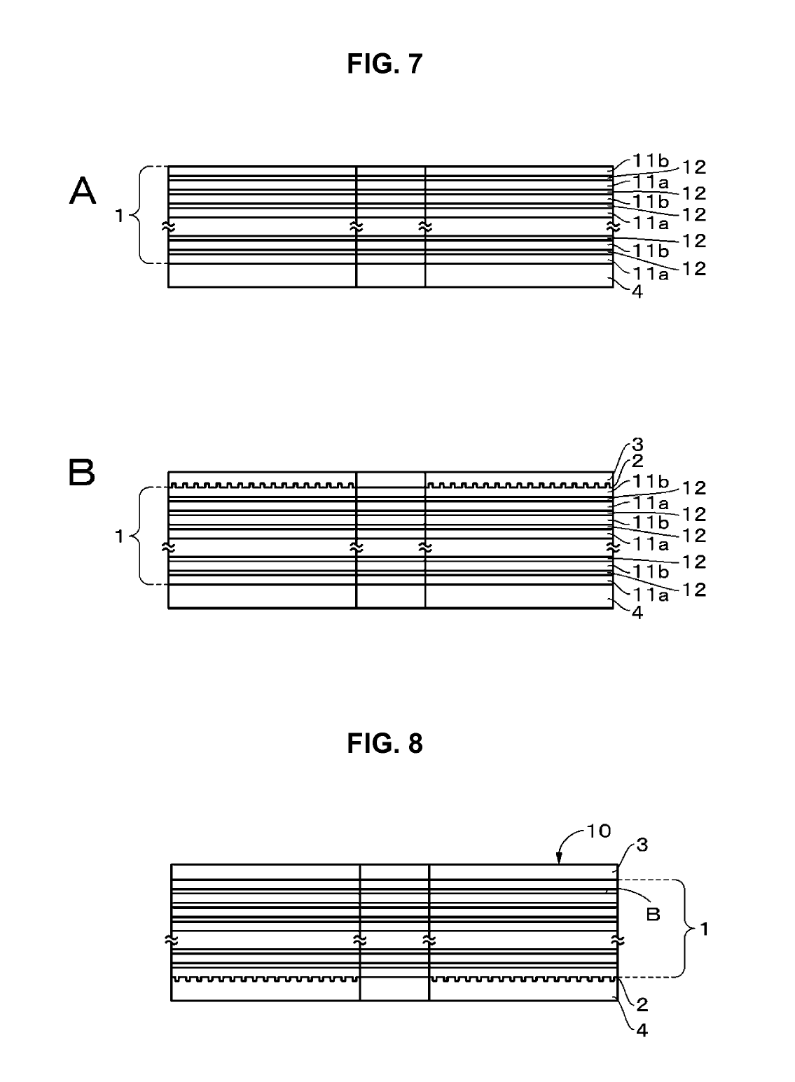

Next, the processes from the “first applying process” to the “second inorganic layer forming process” are repeated a plurality of times. Thus, as illustrated in FIG. 7A, the plurality of first intermediate layers 11a and the plurality of second intermediate layers are alternately laminated on the substrate 4 with the inorganic layers 12, and thus the bulk layer 1 is formed on the substrate 4.

Next, as illustrated in FIG. 7B, the cover layer 3 in which the selective reflection layer 2 is formed is bonded with one main surface of the bulk layer 1 formed on the substrate 4. Thus, the targeted optical information recording medium 10 can be obtained.

### 1.5 Advantages

In this embodiment, the surface of the first intermediate layer 11b and the surface of the second intermediate layer 11b forming the interfaces B1 and B2 have different elastic moduli. Thus, when the functional layer 11c near the interface is irradiated with the laser beam, the interfaces B1 and B2 near the functional layer are deformed in a concave shape on the surface of the functional layer 11c so that the recording marks are formed in the interfaces B. Accordingly, the recording marks can be formed in the interface between the plurality of laminated resin layers.

Since the inorganic layer 12 is formed in the interface B, the heat transfer at the time of the formation of the recording marks is controlled, and thus the satisfactory recording marks are formed. Accordingly, the waveform of a reproduced signal is improved.

### 1.6 Modification Examples

FIG. 8 is a schematic sectional view illustrating an example of another configuration of the optical information recording medium according to the first embodiment of the present application. As illustrated in FIG. 8, a lamination configuration in which a selective reflection layer 2, a bulk layer 1, and a cover layer 3 are sequentially laminated on one main surface of the substrate 4 may be used as the configuration of the optical information recording medium 10. In this configuration, an uneven surface serving as a guide groove guiding a recording or reproduction position is formed on the surface of the substrate 4.

Further, the selective reflection layer 2 may be configured to be formed inside the bulk layer 1. When this configuration is used, the uneven surface serving as a guide groove guiding a recording or reproduction position is formed inside the bulk layer 1 and the selective reflection layer 2 is formed on the uneven surface.

### 2. Second Embodiment

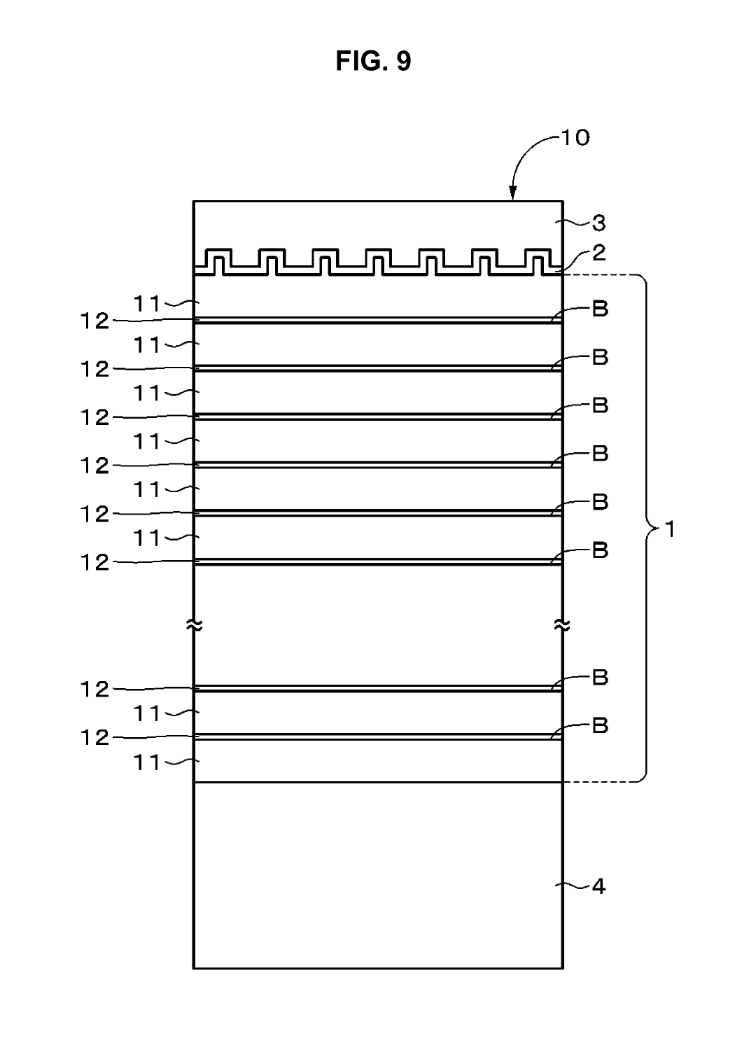

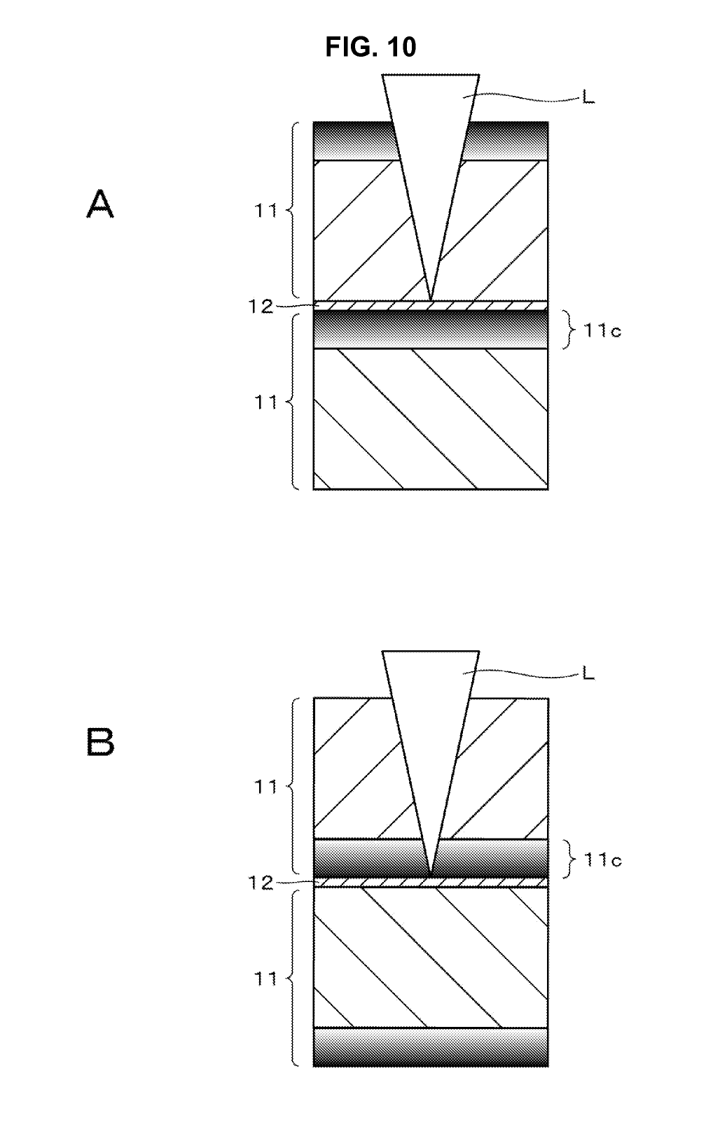

FIG. 9 is a schematic sectional view illustrating an example of one configuration of an optical information recording medium according to a second embodiment of the present application. FIGS. 10A and 10B are schematic sectional views illustrating an example of the configuration of first and second intermediate layers. The optical information recording medium according to the second embodiment is different from the optical information recording medium according to the first embodiment in that a bulk layer 1 has a lamination structure of intermediate layers 11 formed of the same material. A storage elastic modulus E′ of the surface of one intermediate layer (resin layer) 11 forming an interface is different from a storage elastic modulus E′ of the surface of the other intermediate layer (resin layer) 11.

For example, a method of forming an oxidation layer or the like on the surface of the intermediate layer 11 by irradiation with an energy beam such as an ultraviolet ray and a method of separately forming a layer formed of an organic material, an organic and inorganic composite material, or the like on the surface of the intermediate layer 11 can be used as a method of forming the functional layer 11c. In terms of simplicity of the producing process, the former is preferably used.

For example, at least one kind of material selected from the group consisting of a thermoplastic resin, a thermosetting resin, and an energy beam curable resin can be used as the organic material. An ultraviolet curable resin that is cured by an ultraviolet ray is preferably used as an energy beam curable resin composition. For example, a nanocomposite in which an organic material and an inorganic material are composited on a nano-level can be used as the organic and inorganic composite material.

The remaining configuration of the second embodiment other than the above-described configuration is the same as that of the first embodiment.

### EXAMPLES

Hereinafter, examples of the present application will be described in detail, but examples of the present application are not limited thereto.

Examples, Reference Examples, and Comparative Examples of the present application will be described below in the following order.

1. Layer configuration in which inorganic layer with non-optical absorption property is formed in interface

2. Layer configuration in which inorganic layer with optical absorption property is formed in interface

3. Difference in signal characteristics depending on whether inorganic layer is present

4. Mark shape

5. Curable condition dependence of recording characteristics

6. Curable condition dependence of transmittance of intermediate layer

7. Surface analysis of intermediate layer (absorption spectrum)

8. Surface analysis of intermediate layer (oxygen concentration)

### 1. Layer Configuration in which Inorganic Layer with Non-Optical Absorption Property is Formed in Interface

### Example 1-1

First, a glass substrate that had a diameter of 120 mm and included a center hole with a diameter of 15 mm at a center thereof was prepared as a substrate. Next, a UV curable resin composite having the following composition was produced:

Difunctional monomer: fluorene acrylate (produced by Osaka Gas Chemical Co., Ltd., Ogsol EA-0200) of 80 parts by mass;

Monofunctional monomer: benzyl acrylate (produced by Osaka Organic Chemical Co., Ltd) of 20 parts by mass; and

Photopolymerization initiator: Darocure 1173 (produced by Chiba Chemical Co., Ltd) of 3 parts by mass.

Next, after the produced UV curable resin composition was applied to the glass substrate by a spin coating method to form a coated film, the UV curable resin composition was cured by irradiation with an ultraviolet ray of 10 J/cm² by a high-pressure mercury lamp or the like. Thus, a first intermediate layer with a thickness of 20 μm was formed on the glass substrate. Next, the surface of the first intermediate layer was irradiated with an ultraviolet ray of 20 J/cm² by the high-pressure mercury lamp. Thus, an organic functional layer (oxidation layer) was formed on the surface of the first intermediate layer. Next, a SiO₂ layer (an inorganic layer with a non-optical absorption property) with a film thickness of 2 nm was formed on the surface of the first intermediate layer by a sputtering method.

Next, a polycarbonate film which had a center hole in its center and a thickness of 75 μm and in which a groove was formed in one surface was prepared and a selective reflection layer was formed on the groove-formed surface of the film. Next, a colorless and transparent PSA layer with a thickness of 25 μm was formed as the second intermediate layer in the selective reflection layer. Next, the second intermediate layer and the cover layer were formed on the first intermediate layer by bonding this film on the first intermediate layer with the second intermediate layer interposed therebetween. As described above, the targeted optical information recording medium was obtained.

### Example 1-2

An optical information recording medium was obtained in the same way as Example 1-1 except that a film thickness of the SiO₂ layer was set to 5 nm.

### Example 1-3

An optical information recording medium was obtained in the same way as Example 1-1 except that a film thickness of the SiO₂ layer was set to 10 nm.

### Example 1-4

An optical information recording medium was obtained in the same way as Example 1-1 except that a film thickness of the SiO₂ layer was set to 20 nm.

### Comparative Example 1-1

An optical information recording medium was obtained in the same way as Example 1-1 except that the SiO₂ layer was not formed and the second intermediate layer was directly formed on the surface of the first intermediate layer.

(Recording Characteristics)

Information signals were recorded on the optical information recording media obtained as described in Examples 1-1 to 1-4 and Comparative Example 1-1. Recording and reproduction conditions were as follows:

Light strategy: duty 50% Block (8T monotone recording); and

Linear speed at time of recording and reproduction: 4.92 m/s.

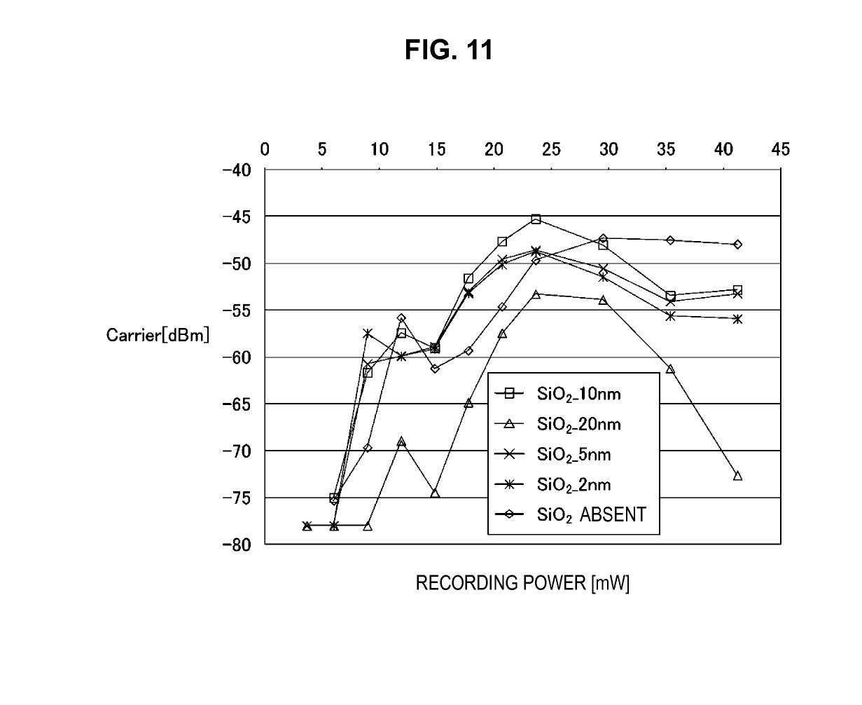

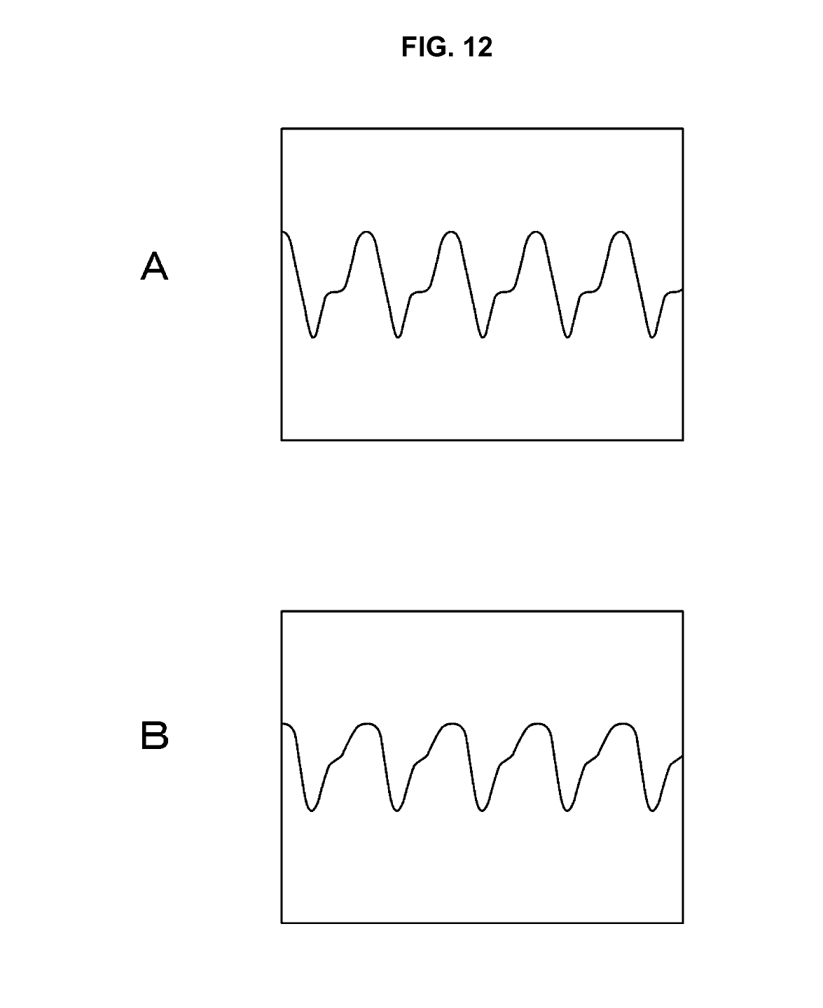

Next, recording power dependences of signal strengths were inspected by reproducing the optical information recording media on which the information signals were recorded. The results are shown in FIG. 11. FIG. 12A is a diagram illustrating a signal waveform of the optical information recording medium (the SiO₂ layer: 30 nm) according to Example 1-3. FIG. 12B is a diagram illustrating a signal waveform of the optical information recording medium (the SiO₂ layer: 0 nm) according to Comparative Example 1-1.

(Reflection Characteristics and Transmission Characteristics)

Reflectances of the optical information recording media obtained as described in Example 1-1 and Comparative Example 1-1 were measured. Here, the reflectance corresponds to light with a wavelength of 405 nm. As a result, the reflectances of the optical information recording media according to Example 1-1 and Comparative Example 1-1 were 0.32% and 0.28%, respectively.

The following can be understood from the evaluation result.

Interface reflection: the ratios of the interface reflections are almost the same when the SiO₂ layer is formed in the interface and when the SiO₂ is not formed in the interface.

Recording sensitivity: the recording sensitivity is rarely changed when the SiO₂ layer is not formed in the interface and when a SiO₂ layer with a film thickness greater than 0 nm and less than 20 nm is formed in the interface. However, when a SiO₂ layer with a film thickness greater than 20 nm is formed in the interface, the recording sensitivity tends to reduce. This is considered to be due to heat damage that may occur when the film thickness is 20 nm.

Accordingly, the thickness of the inorganic layer with a non-optical absorption property is preferably in the range greater than 0 nm and less than 20 nm and is more preferably greater than 0 nm and equal to or less than 10 nm.

Signal waveform: when the SiO₂ layer is not formed in the interface, a signal waveform may be distorted due to the fact that the resin material of the intermediate layer is an elastic body and heat may not be lost. On the other hand, when the SiO₂ layer is formed in the interface, writing finish can be improved compared to the case in which the SiO₂ layer is not formed in the interface. That is, a signal waveform can be further improved when the SiO₂ layer is formed in the interface than when the SiO₂ layer is not formed in the interface.

By controlling heat transfer in the interface, the waveform of a reproduced signal can be improved (line density, track density, or the like can be improved).

In the above-described examples, the case in which the SiO₂ layer is formed as the inorganic layer with a non-optical absorption property has been exemplified. However, even when a dielectric layer such as a TiO₂ layer or a SiN layer is formed rather than the SiO₂ layer, it is possible to obtain the same advantages as in the case in which the SiO₂ layer is formed.

### 2. Layer Configuration in which Inorganic Layer with Optical Absorption Property is Formed in Interface

### Example 2-1

An optical information recording medium was obtained in the same way as Example 1-1 except that a TiN layer (an inorganic layer with an optical absorption property) with a film thickness of 2 nm was formed instead of the SiO₂ layer with a film thickness of 2 nm.

### Example 2-2

An optical information recording medium was obtained in the same way as Example 2-1 except that the film thickness of a TiN layer was set to 5 nm.

### Comparative Example 2-1

An optical information recording medium was obtained in the same way as Example 2-1 except that no TiN layer was formed and the second intermediate layer was directly formed on the surface of the first intermediate layer.

### Example 2-3

An optical information recording medium was obtained in the same way as Example 1-1 except that a carbon layer (an inorganic layer with an optical absorption property) with a film thickness of 3 nm was formed instead of the SiO₂ layer with the film thickness of 2 nm.

### Example 2-4

An optical information recording medium was obtained in the same way as Example 2-3 except that the film thickness of a carbon layer was set to 5 nm.

### Comparative Example 2-2

An optical information recording medium was obtained in the same way as Example 2-3 except that no carbon layer was formed and the second intermediate layer was directly formed on the surface of the first intermediate layer.

(Recording Characteristics)

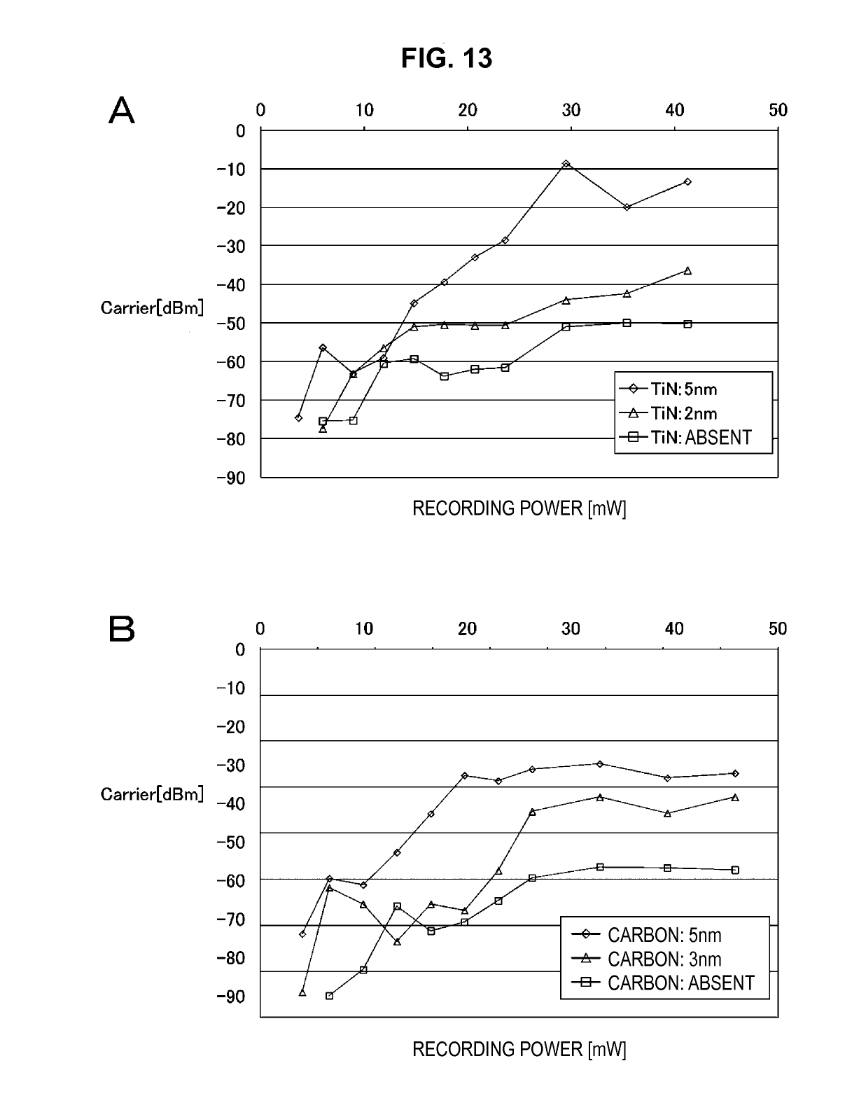

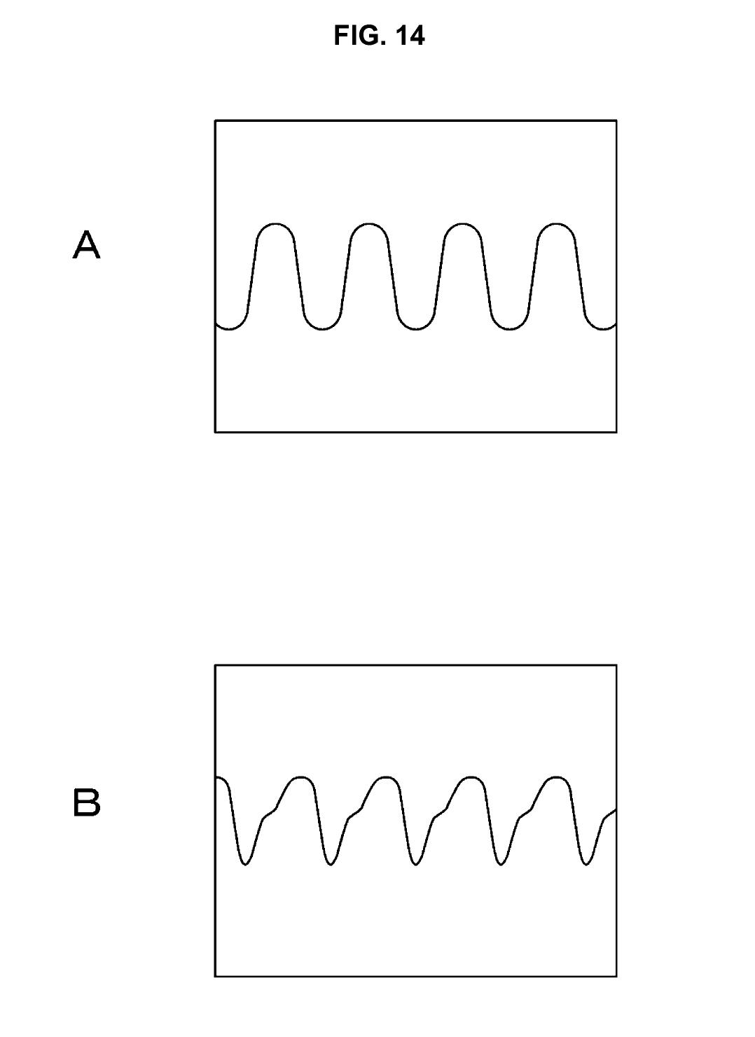

Recording power dependences of the signal strengths for the optical information recording media obtained as described in Examples 2-1 to 2-4 and Comparative Example 2-1 and 2-2 were inspected as in Examples 1-1 to 1-4 and Comparative Example 1-1 described above. The results are illustrated in FIGS. 13A and 13B. FIG. 14A is a diagram illustrating a signal waveform of the optical information recording medium according to Example 2-2. FIG. 14B is a diagram illustrating a signal waveform of the optical information recording medium according to Comparative Example 2-1.

(Reflection Characteristics and Transmission Characteristics)

Reflectances and transmittance of the optical information recording media obtained as described in Examples 2-1 to 2-4 and Comparative Examples 2-1 and 2-2 were measured. Here, the reflectance and the transmittance correspond to light with a wavelength of 405 nm.

Table 1 shows the measurement results of the reflectances and the transmittances of the optical information recording media according to Examples 2-1 and 2-2 and Comparative Example 2-1.

TABLE 1

| | THICKNESS OF | | |
|---|---|---|---|
| | TiN LAYER (nm) | | |
| | 0 | 2 | 5 |
| TRANSMITTANCE (%) | — | — | 96.4 |
| REFLECTANCE (%) | 0.28 | 0.42 | 1.36 |

Table 2 shows the measurement results of the reflectances and the transmittances of the optical information recording media according to Examples 2-3 and 2-4 and Comparative Example 2-2.

TABLE 2

| | THICKNESS OF | | |
|---|---|---|---|
| | CARBON LAYER | | |
| | (nm) | | |
| | 0 | 3 | 5 |
| TRANSMITTANCE (%) | — | 94.5 | 91.5 |
| REFLECTANCE (%) | 0.28 | 0.62 | 0.87 |

The following can be understood from the above-described evaluation results.

Recording sensitivity: as the film thickness of the TiN layer or the carbon layer is thicker (that is, the transmittance decreases), linear absorption increases, and thus the recording sensitivity is improved.

The TiN layer or the carbon layer itself absorbs light, but high transmittance can be obtained. The transmittance has a high value which may not be obtained in an optical information recording medium of the related art such as Blu-ray Disc (registered trademark), but sufficient recording sensitivity can be obtained. This is considered to because the materials of the first and second intermediate layers are organic materials.

Signal strength: when the TiN layer or the carbon layer is formed in the interface, CNR (signal-to-noise ratio) can be improved more than when the TiN layer or the carbon layer is not formed. This is considered to be because reduction in second-order harmonic component, that is, approach of a wavelength to a square wave, is one of the reasons for the improvement in the CNR.

Signal waveform: by forming the TiN layer or the carbon layer in the interface, the waveform of a reproduced signal is improved as in Examples 1-1 to 1-4 and Comparative Example 1-1 described above.

Material dependence of advantage: apart from an amount of light absorption, thermophysical properties such as heat transfer or mechanical characteristics of an organic layer are considered to have an influence on the improvement in the recording sensitivity, the signal strength, and the signal waveform.

The following can be understood when the evaluation results of Examples 1-1 to 1-4 and Examples 2-1 to 2-4 are compared.

When the inorganic layer with an optical absorption property is formed in the interface, it is possible to obtain the same improvement advantages as in the case in which the inorganic layer with a non-optical absorption property is formed in the interface.

When the inorganic layer with an optical absorption property is formed, it is possible to improve the CNR (signal-to-noise ratio), the recording sensitivity, and the like more than when the inorganic layer with a non-optical absorption property is formed.

### 3. Difference in Signal Characteristics Depending on Whether Inorganic Layer is Present

### Example 3-1

An optical information recording medium was obtained in the same way as Example 1-1 except that a BiTeTiN layer (an inorganic layer with an optical absorption property) with a film thickness of 5 nm was formed instead of the SiO₂ layer with a film thickness of 2 nm.

### Comparative Example 3-1

An optical information recording medium was obtained in the same way as Example 2-1 except that no BiTeTiN layer was formed and the second intermediate layer was directly formed on the surface of the first intermediate layer.

(Signal Waveform)

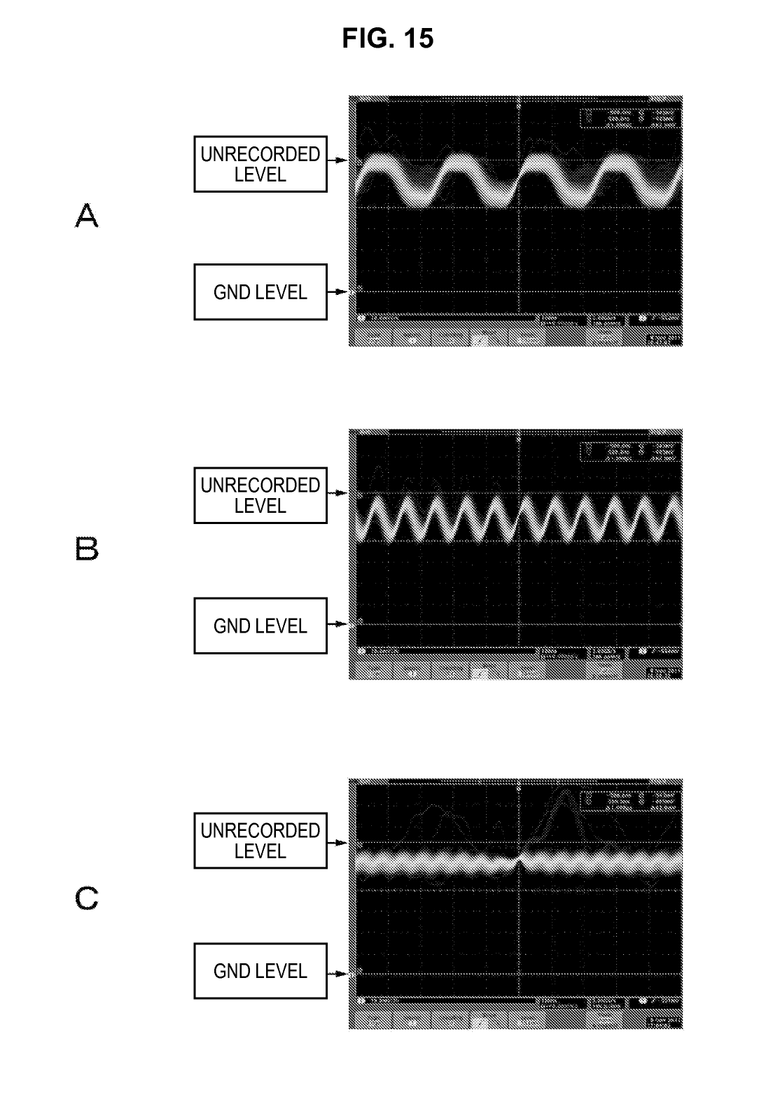

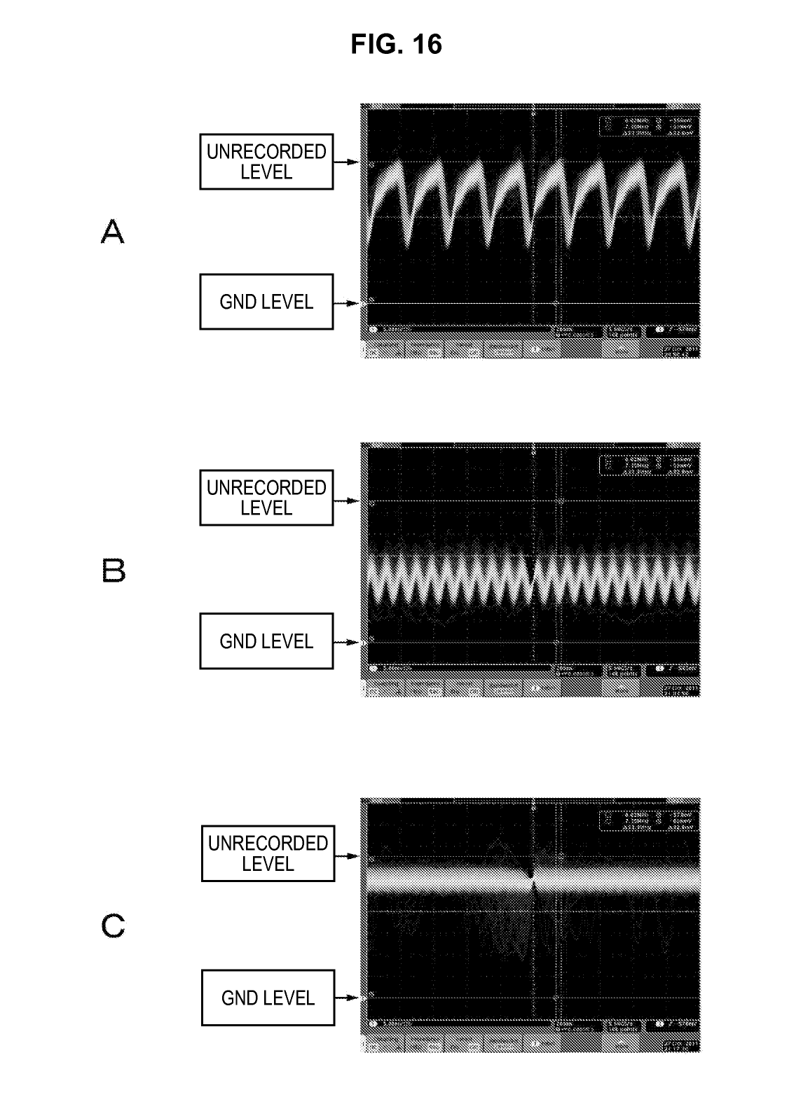

Signal waveforms were evaluated by forming recording marks of 8T, 3T, and 2T on the optical information recording media obtained as described in Example 3-1 and Comparative Example 3-1. The results are illustrated in FIGS. 15A to 15C (Example 3-1) and FIGS. 16A to 16C (Comparative Example 3-1).

Reproduction conditions and the like of the optical information recording medium according to Example 3-1 are shown as follows:

Reflectance: 0.38% (reflectance with respect to light with a wavelength of 405 nm);

Linear speed: 4.92 m/s; and

Reproduction Pw: 2 mW.

Reproduction conditions and the like of the optical information recording medium according to Comparative Example 3-1 are shown as follows:

Reflectance: 0.72% (reflectance with respect to light with a wavelength of 405 nm);

Linear speed: 4.92 m/s; and

Reproduction Pw: 2 mW.

The following can be understood from FIGS. 15A to 15C and 16A to 16C.

By forming the inorganic layer in the interface, the reproduced signal can be set to a square wave.

By forming the inorganic layer in the interface, asymmetry of 2T can be lowered.

By forming the inorganic layer in the interface, the CNR (signal-to-noise ratio) can be increased.

Thus, by separating the recording marks, the line density can be improved. Accordingly, random pattern recording can be performed.

In the above-described examples, the case in which the BiTeTiN layer is formed as the inorganic layer with an optical absorption property has been exemplified. However, even when an inorganic layer such as a BiTeZrN layer is formed, it is possible to obtain the same advantages as when the BiTeTiN layer is formed.

### 4. Mark Shape

### Example 4-1

An optical information recording medium was obtained in the same way as Example 1-1 except that a BiTeZrN layer (an inorganic layer with an optical absorption property) with a film thickness of 7 nm was formed instead of the SiO₂ layer with a film thickness of 2 nm.

### Example 4-2

An optical information recording medium was obtained in the same way as Example 1-1 except that a BiTeTiN layer (an inorganic layer with an optical absorption property) with a film thickness of 5 nm was formed instead of the SiO₂ layer with a film thickness of 2 nm.

(Mark Shape)

The mark shapes of the optical information recording media obtained as described in Examples 4-1 and 4-2 were inspected as follows.

First, information signals were recorded on the optical information recording media obtained as described in Examples 4-1 and 4-2. Recording and reproduction conditions were as follows:

Light strategy: duty 50% Block (8T monotone recording); and

Linear speed at time of recording and reproduction: 4.92 m/s.

Next, the second intermediate layer (PSA layer) was removed from the surface of the inorganic layer (the BiTeZrN layer or the BiTeTiN layer) and the surface of the inorganic layer was inspected by an atomic force microscope (AFM) and a scanning electron microscope (SEM).

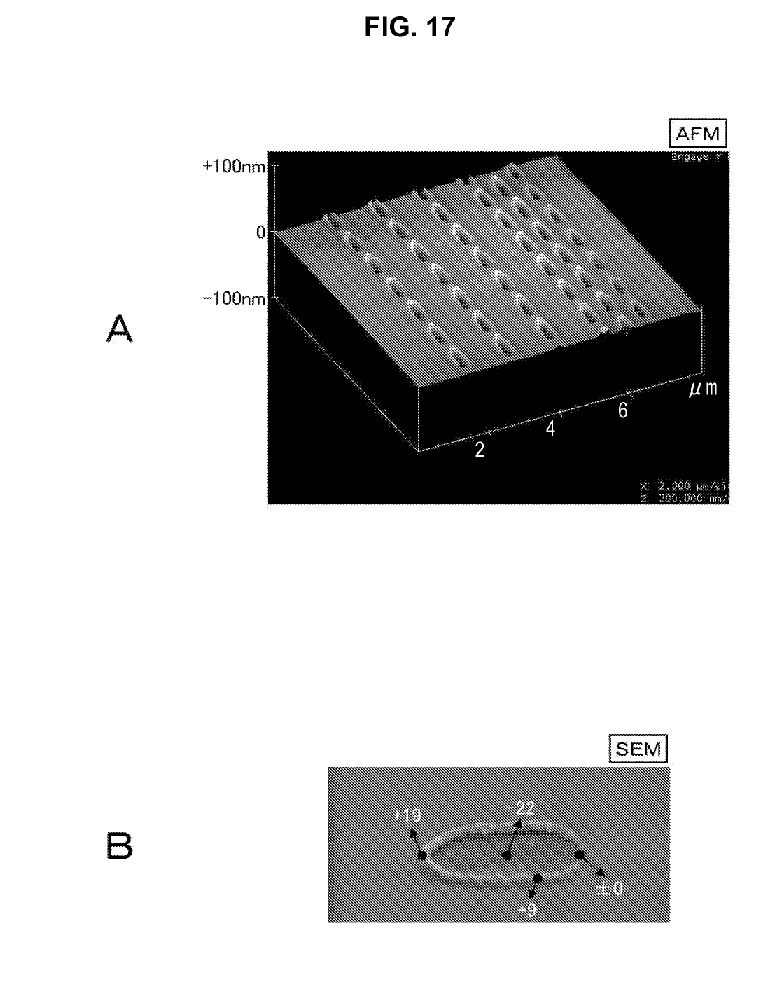

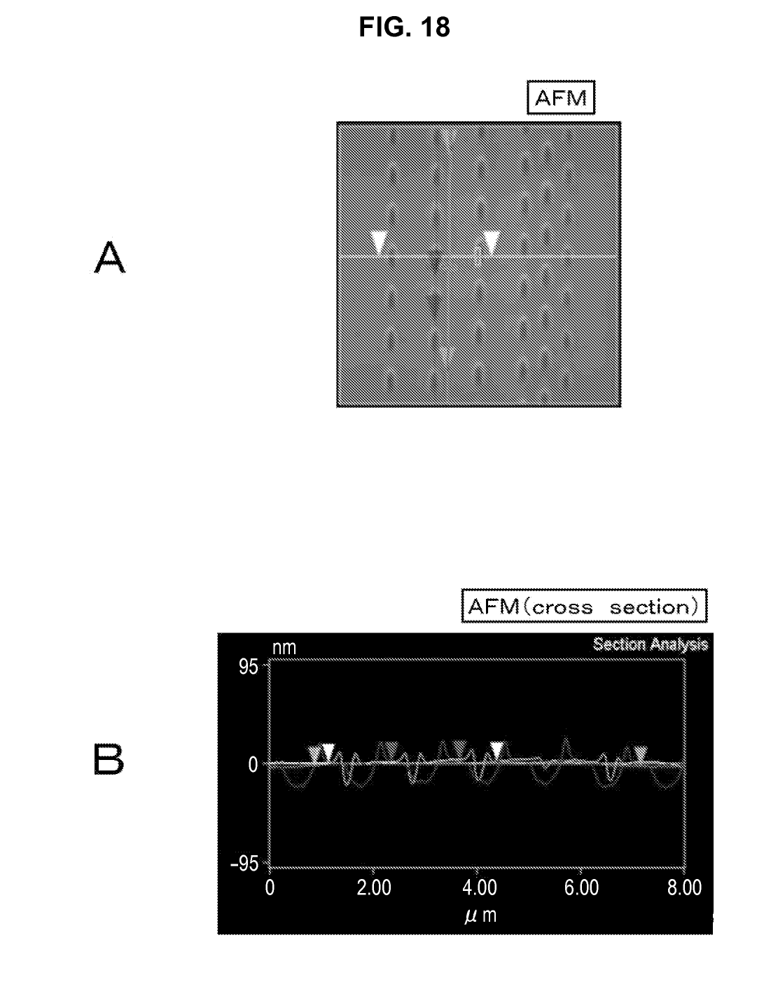

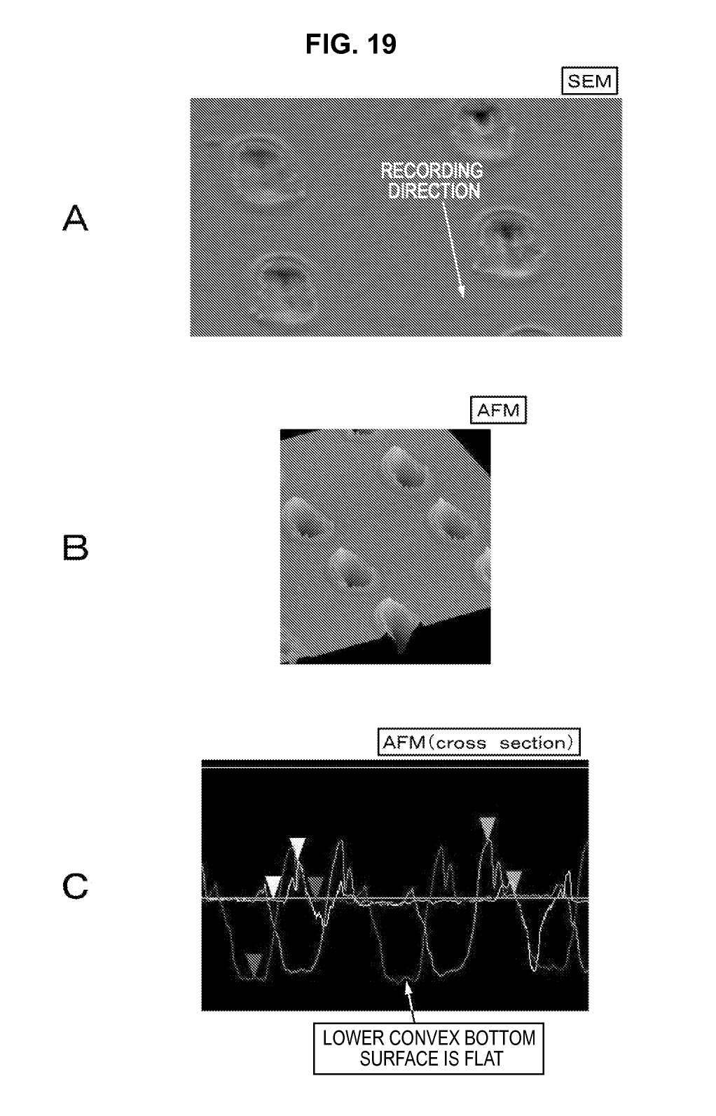

FIG. 17A is a diagram illustrating an AEM image of the BiTeZrN layer according to Example 4-1. FIG. 17B is a diagram illustrating an SEM image of the BiTeZrN layer according to Example 4-1. FIG. 18A is a diagram illustrating an AFM image of the BiTeZrN layer according to Example 4-1. FIG. 18B is a diagram illustrating a cross-sectional surface profile of the AFM image illustrated in FIG. 18A. FIG. 19A is a diagram illustrating an SEM image of the BiTeTiN layer according to Example 4-2. FIG. 19B is a diagram illustrating an AFM image of the BiTeTiN layer according to Example 4-1. FIG. 19C is a diagram illustrating a cross-sectional surface profile of the AFM image illustrated in FIG. 19B. Further, the numbers recorded in FIG. 17B indicate the height of a convex portion and the depth of a concave portion by setting a flat surface in which the recording mark is not formed as a reference. The units of the height and the depth are “nm,” the height of the convex portion indicates “positive,” and the depth of the concave portion indicates “negative.”

The following can be understood from the above-described inspection result.

In a portion in which the recording mark is formed, the inorganic layer is lost and the surface of the first intermediate layer (organic functional layer) is depressed. The bottom surface of the recording mark in the concave shape has a planar shape. The reproduced signal waveform (see FIG. 15A) with a rectangular shape described above is considered to be obtained by forming the recording mark with the bottom surface shape.

### 5. Curable Condition Dependence of Recording Characteristics

### Reference Example 5-1

First, a glass substrate that had a diameter of 120 mm and included a center hole with a diameter of 15 mm at a center thereof was prepared as a substrate. Next, a UV curable resin composite having the following composition was produced:

Difunctional monomer: fluorene acrylate (produced by Osaka Gas Chemical Co., Ltd., Ogsol EA-0200) of X parts by mass;

Monofunctional monomer: benzyl acrylate (produced by Osaka Organic Chemical Co., Ltd) of (100-X) parts by mass; and

Photopolymerization initiator: Darocure 1173 (produced by Chiba Chemical Co., Ltd) of 2 to 5 parts by mass.

Here, the monofunctional monomer and difunctional monomer were composited so that X was within a range of 50 parts by mass to 90 parts by mass.

Next, after the produced UV curable resin composition was applied to the glass substrate by a spin coating method to form a coated film, a UV curable resin composition was cured by irradiation with an ultraviolet ray of 10 J/cm² by a high-pressure mercury lamp. Thus, a first intermediate layer with a thickness of 20 μm was formed on the glass substrate. Next, the surface of the first intermediate layer was irradiated with an ultraviolet ray of 2.5 J/cm² by the high-pressure mercury lamp.

Next, a polycarbonate film which had a center hole in its center and a thickness of 75 μm and in which a groove was formed in one surface was prepared and a selective reflection layer was formed on the groove-formed surface of the film. Next, a colorless and transparent PSA layer with a thickness of 25 μm was formed as the second intermediate layer in the selective reflection layer. Next, the second intermediate layer and the cover layer were formed by bonding this film on the first intermediate layer with the second intermediate layer interposed therebetween. As described above, the targeted optical information recording medium was obtained.

### Reference Example 5-2

An optical information recording medium was obtained in the same way as Reference Example 5-1 except that the amount of ultraviolet ray radiated to the surface of the first intermediate layer was changed from 2.5 J/cm² to 11 J/cm².

### Reference Example 5-3

An optical information recording medium was obtained in the same way as Reference Example 5-1 except that the amount of ultraviolet ray radiated to the surface of the first intermediate layer was changed from 2.5 J/cm² to 20 J/cm².

(Recording Characteristics)

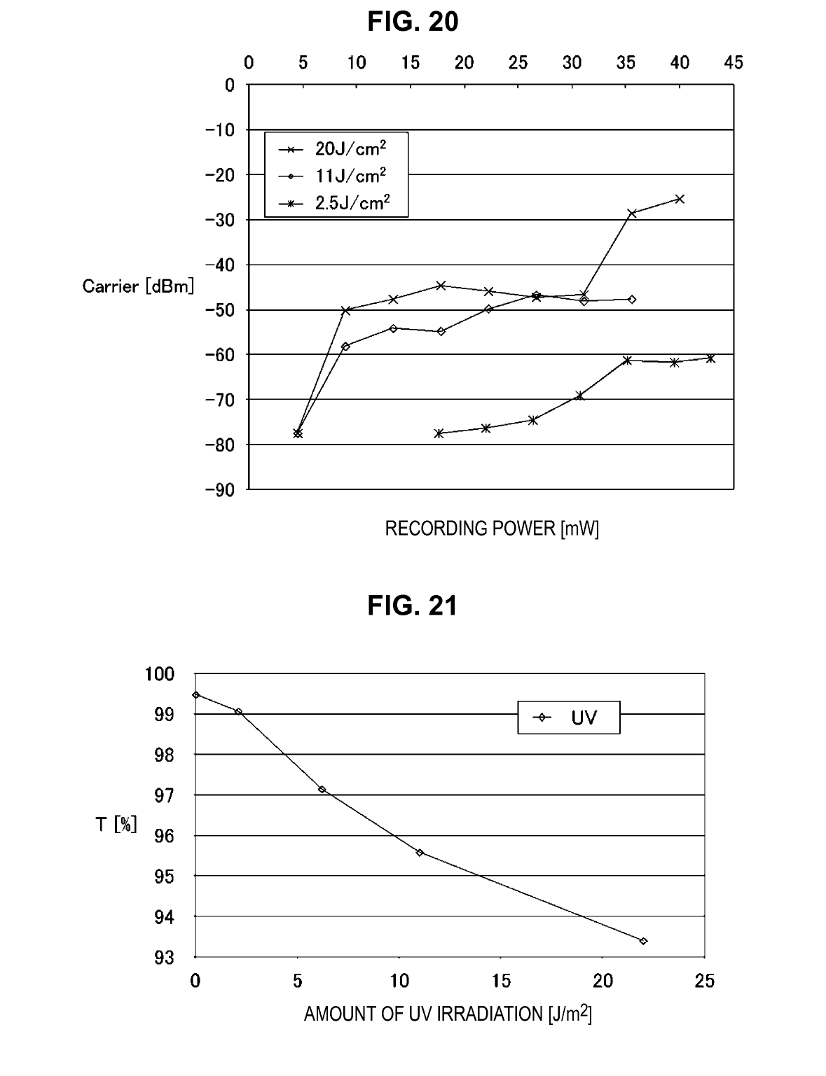

Curable condition dependence of the signal strength was evaluated by changing the recording power of the optical information recording media obtained as described in Reference Examples 5-1 to 5-3 and recording an information signal. The result is illustrated in FIG. 20.

From FIG. 20, it can be understood that a signal amplitude tends to increase with an increase in a dose amount.

### 6. Curable Condition Dependence of Transmittance of Intermediate Layer

### Reference Example 6-1

First, a glass substrate that had a diameter of 120 mm and included a center hole with a diameter of 15 mm at a center thereof was prepared as a substrate. Next, a UV curable resin composite having the following composition was produced:

Difunctional monomer: fluorene acrylate (produced by Osaka Gas Chemical Co., Ltd., Ogsol EA-0200) of X parts by mass;

Monofunctional monomer: benzyl acrylate (produced by Osaka Organic Chemical Co., Ltd) of (100-X) parts by mass; and

Photopolymerization initiator: Darocure 1173 (produced by Chiba Chemical Co., Ltd) of 2 to 5 parts by mass.

Here, the monofunctional monomer and difunctional monomer were composited so that X was within a range of 50 parts by mass to 90 parts by mass.

Next, after the produced UV curable resin composition was applied to the glass substrate by a spin coating method to form a coated film, a UV curable resin composition was cured by irradiation with an ultraviolet ray of 10 J/cm² by a high-pressure mercury lamp. Thus, an intermediate layer with a thickness of 20 μm was formed on the glass substrate. As described above, the targeted laminate was obtained.

### Reference Example 6-2

A laminate was obtained in the same way as Reference Example 6-1 except that an intermediate layer was formed, and then the surface of the intermediate layer was irradiated with an ultraviolet ray of 2 J/cm² by a high-pressure mercury lamp.

### Reference Example 6-3

A laminate was obtained in the same way as Reference Example 6-2 except that the amount of ultraviolet ray radiated to the surface of the intermediate layer was changed from 2 J/cm² to 6 J/cm².

### Reference Example 6-4

A laminate was obtained in the same way as Reference Example 6-2 except that the amount of ultraviolet ray radiated to the surface of the intermediate layer was changed from 2 J/cm² to 11 J/cm².

### Reference Example 6-5

A laminate was obtained in the same way as Reference Example 6-2 except that the amount of ultraviolet ray radiated to the surface of the intermediate layer was changed from 2 J/cm² to 22 J/cm².

(Transmission Characteristics)

The transmittances of the laminates obtained as described in Reference Examples 6-1 to 6-5 were measured. The results are illustrated in FIG. 21. From FIG. 21, it can be understood that the transmittance tends to be attenuated with an increase in the dose amount. That is, it can be understood that linear absorption tends to increase with an increase in the dose amount.

### 7. Surface Analysis of Intermediate Layer

### Absorption Spectrum

### Reference Example 7-1

A laminate was obtained in the same way as Reference Example 6-2 except that the amount of ultraviolet ray radiated to the surface of the intermediate layer was changed from 2 J/cm² to 5.5 J/cm².

### Reference Example 7-2

A laminate was obtained in the same way as Reference Example 6-2 except that the amount of ultraviolet ray radiated to the surface of the intermediate layer was changed from 2 J/cm² to 11 J/cm².

### Reference Example 7-3

A laminate was obtained in the same way as Reference Example 6-2 except that the amount of ultraviolet ray radiated to the surface of the intermediate layer was changed from 2 J/cm² to 16.5 J/cm².

### Reference Example 7-4

A laminate was obtained in the same way as Reference Example 6-2 except that the amount of ultraviolet ray radiated to the surface of the intermediate layer was changed from 2 J/cm² to 22 J/cm².

(Surface Analysis)

The surface (a surface layer of about 1 μm) of the intermediate layer of each of the laminates obtained as described in Reference Examples 7-1 to 7-4 was analyzed with attenuated total reflection-infrared spectroscopy: ATR-IR).

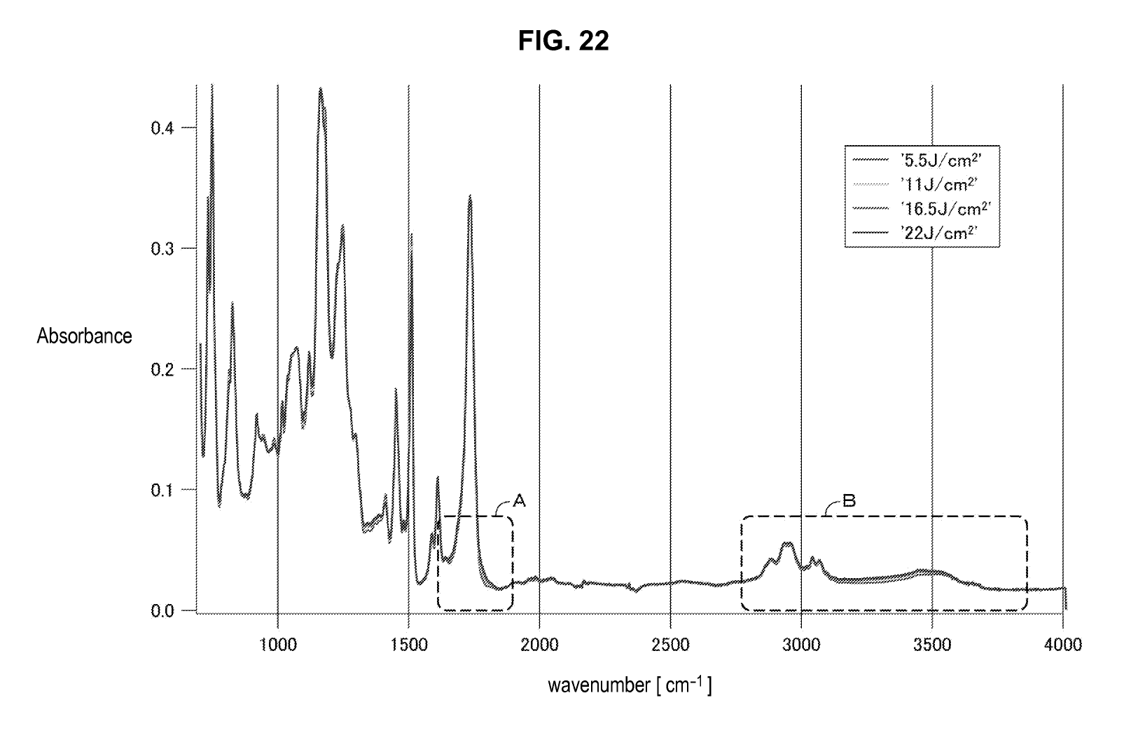

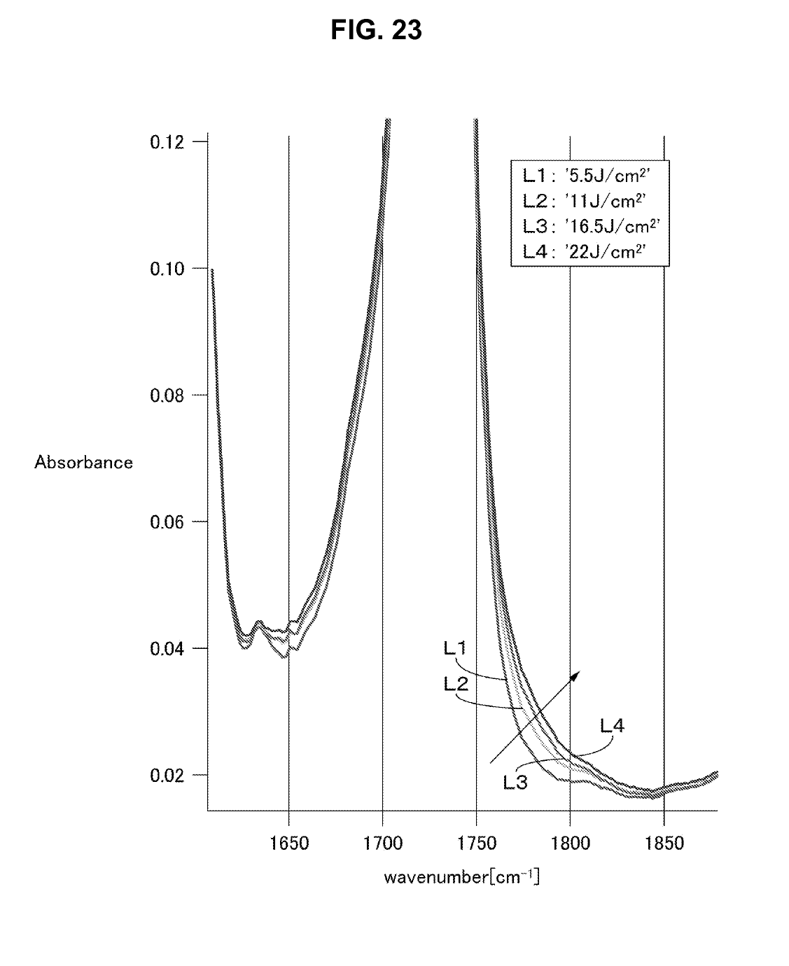

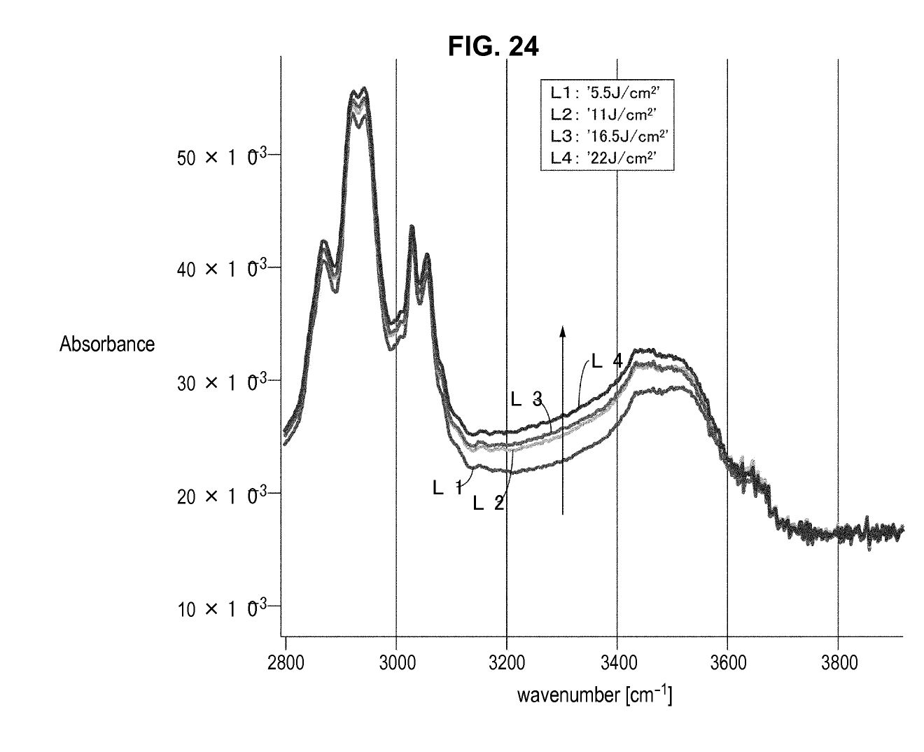

FIG. 22 is a diagram illustrating an ATR-IR absorption spectrum of the intermediate layer surface. FIG. 23 is an expanded diagram illustrating a region A illustrated in FIG. 22. FIG. 24 is an expanded diagram illustrating a region B illustrated in FIG. 22. From FIGS. 23 and 24, it can be understood that spectrum widths increase (broaden). This increase implies that an oxidation layer is formed on the surface of the intermediate layer.

### 8. Surface Analysis of Intermediate Layer

### Oxygen Concentration

### Reference Example 8

A laminate was obtained in the same way as Reference Example 6-2 except that the amount of ultraviolet ray radiated to the surface of the first intermediate layer was changed from 2 J/cm² to 20 J/cm².

(Peak Strength)

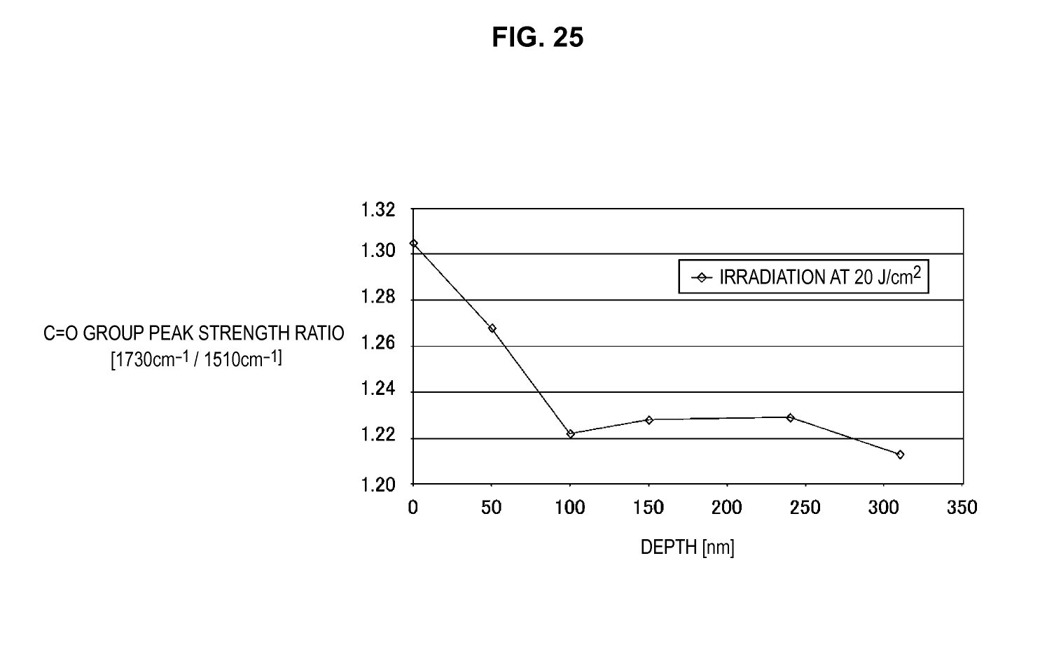

A relation between a C═O group peak strength ratio and a depth of the surface of an intermediate layer of the laminate obtained in the above-described way in Reference Example 8 was inspected. The result is illustrated in FIG. 25. From FIG. 25, it can be understood that the oxidation layer is present up to about 100 nm from the surface of the intermediate layer and the concentration of the oxidation layer at about 50 nm is half.

The specific examples of the present application have been described, but examples of the present application are not limited to the above-described examples. Various modifications based on the technical spirit of the present application can be made.

For example, the configurations, the methods, the processes, the shapes, the materials, the numerical values, and the like in the above-described examples are merely examples. Different configurations, methods, processes, shapes, materials, numerical values, and the like may be used as necessary.

The configurations, the methods, the processes, the shapes, the materials, the numerical values, and the like in the above-described examples can be combined without departing from the gist of the present application.

It should be understood by those skilled in the art that various modifications, combinations, sub-combinations and alterations may occur depending on design requirements and other factors insofar as they are within the scope of the appended claims or the equivalents thereof.

Additionally, the present application may also be configured as below.

(1) An optical information recording medium including:

a plurality of laminated resin layers; and

an inorganic layer that is formed in an interface between the resin layers,

wherein storage elastic moduli are different when the interface is assumed to be a boundary, and

wherein an information signal is recorded in the interface.

(2) The optical information recording medium according to (1), wherein the inorganic layer has a non-absorption property for a beam used to record the information signal.
(3) The optical information recording medium according to (1), wherein the inorganic layer has an absorption property for a beam used to record the information signal.
(4) The optical information recording medium according to any one of (1) to (3),

wherein the interface is formed by a first surface and a second surface of the resin layers, and

wherein the first surface and the second surface have the different storage elastic moduli.

(5) The optical information recording medium according to (4), wherein the resin layer includes a region that absorbs a beam used to record the information signal in the vicinity of the first surface.
(6) The optical information recording medium according to (5), wherein the information signal is recorded as a recording mark in a concave shape with reference to the first surface.
(7) The optical information recording medium according to any one of (5) and (6), wherein the region is an oxidation region.
(8) The optical information recording medium according to any one of (1) to (7), wherein the resin layer includes an ultraviolet curable resin or a thermosetting resin.
(9) The optical information recording medium according to any one of (1) to (7),

wherein the resin layer includes a first resin layer including an ultraviolet curable resin or a thermosetting resin and a second resin layer including an adhesive, and

wherein the first resin layer and the second resin layer are adjacent with the inorganic layer interposed therebetween.

(10) A laminate for an optical information recording medium, including:

a plurality of laminated resin layers; and

an inorganic layer that is formed in an interface between the resin layers,

wherein storage elastic moduli are different when the interface is assumed to be a boundary, and

wherein an information signal is recorded in the interface.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An optical information recording medium comprising:
a plurality of laminated resin layers; and
an inorganic layer that is formed in an interface between the resin layers,
wherein storage elastic moduli are different when the interface is assumed to be a boundary, and
wherein an information signal is recorded in the interface.

2. The optical information recording medium according to claim 1, wherein the inorganic layer has a non-absorption property for a beam used to record the information signal.

3. The optical information recording medium according to claim 1, wherein the inorganic layer has an absorption property for a beam used to record the information signal.

4. The optical information recording medium according to claim 1,
wherein the interface is formed by a first surface and a second surface of the resin layers, and
wherein the first surface and the second surface have the different storage elastic moduli.

5. The optical information recording medium according to claim 4, wherein the resin layer includes a region that absorbs a beam used to record the information signal in the vicinity of the first surface.

6. The optical information recording medium according to claim 5, wherein the information signal is recorded as a recording mark in a concave shape with reference to the first surface.

7. The optical information recording medium according to claim 5, wherein the region is an oxidation region.

8. The optical information recording medium according to claim 1, wherein the resin layer includes an ultraviolet curable resin or a thermosetting resin.

9. The optical information recording medium according to claim 1,
wherein the resin layer includes a first resin layer including an ultraviolet curable resin or a thermosetting resin and a second resin layer including an adhesive, and
wherein the first resin layer and the second resin layer are adjacent with the inorganic layer interposed therebetween.

10. A laminate for an optical information recording medium, comprising:
a plurality of laminated resin layers; and
an inorganic layer that is formed in an interface between the resin layers,
wherein storage elastic moduli are different when the interface is assumed to be a boundary, and
wherein an information signal is recorded in the interface.
